(19) United States
(12) Patent Application Publication
(10) Pub. No.: US 2002/0176511 A1
(43) Pub. Date: Nov. 28, 2002

(54) High pulse-rate radio-frequency apparatus and associated methods

(76) Inventors: Larry W. Fullerton, Brownsboro, AL (US); Marcus H. Pendergrass, Huntsville, AL (US)

Correspondence Address: Maximilian R. Peterson, O'KEEFE, EGAN & PETERMAN, Building C, Suite 200, 1101 Capital of Texas Highway South, Austin, TX, 78746, US

(21) Appl. No.: 09/811,326

(22) Filed: Mar. 16, 2001

(51) Int. Cl. H04B 15/00

(52) U.S. Cl. 375/285; 375/296; 375/346

(57) ABSTRACT

A radio-frequency (RF) apparatus includes a transmitter circuitry that transmits a plurality of pulses into a multipath propagation medium. A transmitter code-circuitry codes the plurality of pulses so as to improve the pulse rate of the transmitter circuitry.

### TECHNICAL FIELD OF THE INVENTION

This invention relates to signaling, communication, ranging, and positioning systems and, more particularly, to improving pulse rates in ultra-wideband communication, ranging, and positioning systems.

### BACKGROUND

The number of applications for wireless and telecommunication technologies has increased steadily in recent years. Wireless devices have either augmented existing wired devices or displaced them entirely. The proliferation of wireless devices in high data-rate applications has resulted in a need for higher data throughput in those devices. Moreover, an increase in the number of users has resulted in the crowding of the radio spectrum, i.e., a large number of radio-frequency devices vying for a part of the radio spectrum to use.

A new technology, called ultra-wideband radio or impulse radio, promises to help overcome the crowding of the radio spectrum. Unlike a traditional radio system that uses sine-waves, ultra-wideband radio uses pulses, often known as Gaussian monocycles. Ultra-wideband systems allow a number of devices to share the same radio spectrum, thus help to alleviate the crowding of the radio spectrum.

Regardless of whether one uses a traditional or an ultra-wideband radio system, one must still overcome another hurdle in order to achieve high data-throughput. Radio waves must often travel in a multipath environment, i.e., an environment with a number of objects or obstructions in it. The objects or obstructions interact with the radio waves, for example, reflect them or cause interference among the waves. Moreover, the interaction of a single transmitted pulse with a multipath environment may result in a transient signal that takes a relatively long time to decay. The data throughput of a pulse-transmission communication system would suffer if the system simply waited for the transient signal of a transmitted pulse to expire before transmitting the next pulse. Unfortunately, no known techniques exist that enable a communication system to transmit pulses before the multipath transients of the previous pulses have dissipated. Thus, a need exists for a communication system with an improved data throughput that is immune to the transients of the pulses.

### SUMMARY OF THE INVENTION

One aspect of the invention contemplates radio-frequency (RF) apparatus or systems with improved pulse rates. In one embodiment, RF apparatus according to the invention includes a transmitter circuitry configured to transmit a plurality of pulses into a multipath propagation medium. A transmitter code-circuitry couples to the transmitter circuitry. The transmitter code-circuitry codes the plurality of pulses so as to improve the output pulse-rate of the transmitter circuitry.

In another embodiment, RF circuitry according to the invention has improved pulse-rate. The RF circuitry includes an antenna, a transmitter circuitry, a code circuitry, and a multiplier circuitry. The transmitter circuitry provides a plurality of output pulses. The code circuitry supplies a plurality of code pulses selected so as to improve the output pulse-rate of the transmitter circuitry. The multiplier circuitry couples to the transmitter circuitry, the code circuitry, and the antenna. The multiplier circuitry multiplies each of the plurality of output pulses with a corresponding pulse in the plurality of code pulses and provides the resulting product to the antenna.

Yet another embodiment of the invention relates to RF systems that include a transmitter circuitry with improved output-pulse rate. The transmitter circuitry provides a plurality of output pulses to a propagation medium. The transmitter circuitry includes transmitter code-circuitry that codes the plurality of output pulses so as to improve the output pulse-rate of the transmitter circuitry. The RF system includes a receiver circuitry that receives the plurality of output pulses from the propagation medium. The receiver circuitry includes receiver code-circuitry that decodes the plurality of output pulses.

Another aspect of the invention relates to methods for improving the output pulse-rate of RF apparatus, circuitry, or systems. In one embodiment, a method according to the invention includes providing a transmitter circuitry that supplies a plurality of output pulses. The method also includes providing a transmitter code-circuitry, and coding the plurality of output pulses so as to improve the output pulse-rate of the RF apparatus.

In another embodiment, a method according to the invention improves the output pulse-rate of an RF apparatus. The method includes providing an antenna and a transmitter circuitry configured to supply a plurality of output pulses. The method includes coding the plurality of output pulses by using a plurality of code components selected so as to improve the output pulse-rate of the RF apparatus. The method also includes multiplying each of the plurality of output pulses with a corresponding component in the plurality of code components to provide a plurality of product signals, and supplying each of the plurality of product signals to the antenna.

In yet another embodiment, a method according to the invention improves the pulse transmission rate in an RF system. The method includes providing a transmitter circuitry and a receiver circuitry. The transmitter circuitry provides a plurality of output pulses to a propagation medium. The receiver circuitry receives the plurality of output pulses from the propagation medium. The method includes coding the plurality of output pulses by using a transmitter code-circuitry that supplies a plurality of code pulses configured to improve the output pulse rate of the transmitter circuitry, and decoding in the receiver the plurality of output pulses by using a receiver code-circuitry.

### DESCRIPTION OF THE DRAWINGS

The appended drawings illustrate only exemplary embodiments of the invention. The drawings should therefore not be construed to limit the scope of the invention because the inventive concepts lend themselves to other embodiments within the knowledge of a person skilled in the art who has the benefit of this disclosure of the invention. Like numerals in the drawings refer to the same, similar, or equivalent components, functions, systems, steps, elements, apparatus, etc.

FIG. 1A illustrates a representative Gaussian Monocycle waveform in the time domain.

FIG. 1B illustrates the frequency domain amplitude of the Gaussian Monocycle of FIG. 1A.

FIG. 2A illustrates a pulse train comprising pulses as in FIG. 1A.

FIG. 2B illustrates the frequency domain amplitude of the waveform of FIG. 2A.

FIG. 3 illustrates the frequency domain amplitude of a sequence of time coded pulses.

FIG. 4 illustrates a typical received signal and interference signal.

FIG. 5A illustrates a typical geometrical configuration giving rise to multipath received signals.

FIG. 5B illustrates exemplary multipath signals in the time domain.

FIGS. 5C-5E illustrate a signal plot of various mulitipath environments.

FIGS. 5F illustrates the Rayleigh fading curve associated with non-impulse radio transmissions in a multipath environment.

FIG. 5G illustrates a plurality of multipaths with a plurality of reflectors from a transmitter to a receiver.

FIG. 5H graphically represents signal strength as volts vs. time in a direct path and multipath environment.

FIG. 6 illustrates a representative impulse radio transmitter functional diagram.

FIG. 7 illustrates a representative impulse radio receiver functional diagram.

FIG. 8A illustrates a representative received pulse signal at the input to the correlator.

FIG. 8B illustrates a sequence of representative impulse signals in the correlation process.

FIG. 8C illustrates the output of the correlator for each of the time offsets of FIG. 8B.

FIG. 9 depicts a communication system that includes a transmitter circuitry transmitting a radio signal to a receiver circuitry.

FIG. 10A illustrates a pulse transmitted by the transmitter circuitry in FIG. 9.

FIG. 10B depicts a pulse received by the receiver circuitry in the system shown in FIG. 9.

FIG. 11 shows a communication system that includes a transmitter circuitry and a receiver circuitry. The transmitter circuitry transmits a pulse into a propagation medium. The propagation medium contains an object that causes multipath signals to arrive at the receiver circuitry.

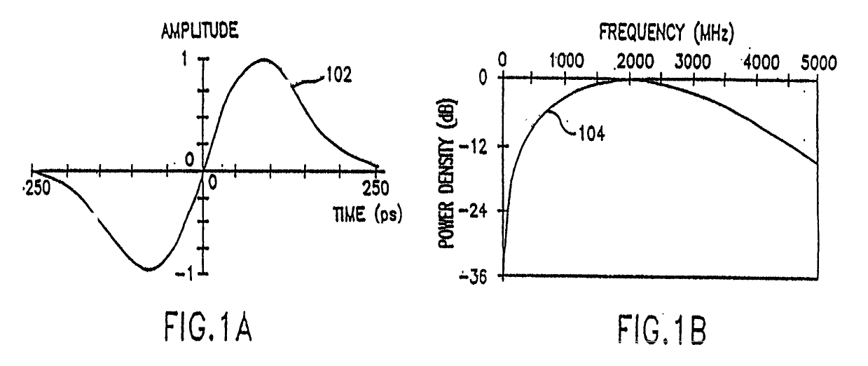

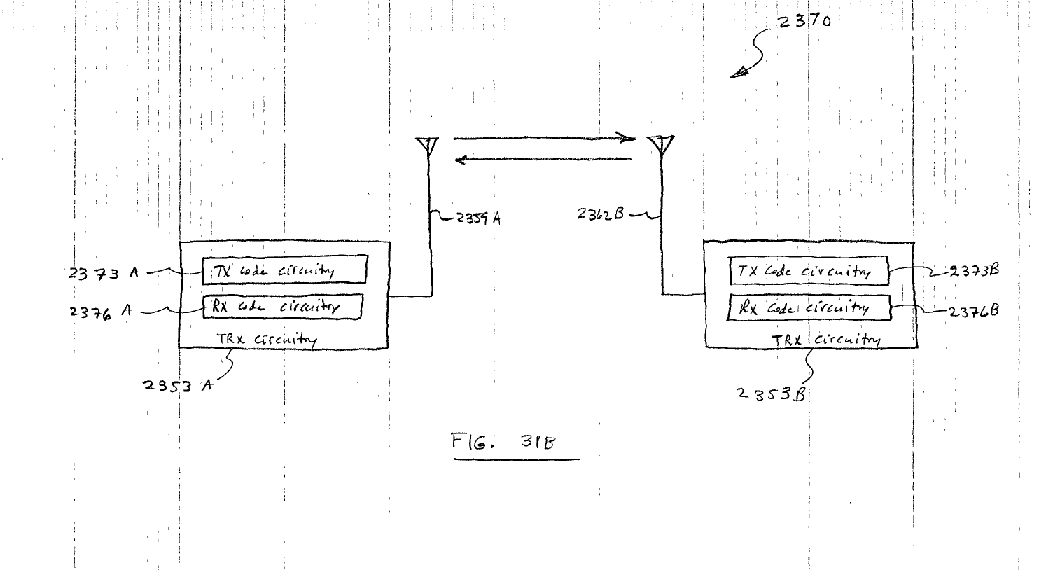

FIG. 1 2A depicts the signal that the transmitter circuitry transmits in the system of FIG. 11.

FIG. 12B shows the multipath signals that the receiver circuitry of FIG. 11 receives.

FIG. 13 illustrates a communication system that includes a transmitter circuitry and a receiver circuitry. The transmitter circuitry transmits a pulse into a propagation medium. The propagation medium contains four objects that cause multipath signals to arrive at the receiver circuitry.

FIG. 14A depicts the signal that the transmitter circuitry transmits in the system of FIG. 13.

FIG. 14B shows the multipath signals that the receiver circuitry of FIG. 13 receives.

FIG. 15A depicts a signal that a transmitter circuitry transmits into a propagation medium. The propagation medium contains a plurality of objects that cause multipath signals to arrive at a receiver circuitry. The transmitter circuitry and the receiver circuitry may be similar to those shown in FIG. 13.

FIG. 15B shows the multipath signals corresponding to the transmitted signal of FIG. 15A that the receiver circuitry receives.

FIG. 16 illustrates a general code sequence. The code sequence shows the various amplitudes, and the time-hopping sequence, of the code components.

FIGS. 17A shows a single pulse, for example, a Gaussian monocycle, that one may use to produce a pulse train.

FIG. 17B depicts a code sequence that one may use together with the pulse shown in FIG. 17A to produce a pulse train.

FIG. 17C illustrates a pulse train that results from convolving the pulse in FIG. 17A with the code sequence in FIG. 17B.

FIG. 18 depicts an example of a burst signal.

FIG. 19A depicts a single pulse, for example, a Gaussian monocycle, that a transmitter may transmit to a receiver.

FIG. 19B shows an example of a receiver pulse template.

FIG. 19C illustrates a coded pulse train that the receiver receives. The transmitter uses a code sequence to produce the transmitted pulse train.

FIG. 19D shows the receiver template signal convolved with the code sequence.

FIG. 20 shows the autocorrelation of the amplitude sequence of a code with power normalization.

FIG. 21A depicts a pulse train in a system that uses a rectangular template signal for correlation.

FIG. 21B illustrates the rectangular template signal.

FIG. 21C shows the results of correlating the pulse train of FIG. 21A with the template signal of FIG. 21B.

FIG. 22A illustrates a pulse train in a system that uses a matched template signal for correlation.

FIG. 22B depicts the matched template signal.

FIG. 22C illustrates the results of correlating the pulse train of FIG. 22A with the template signal of FIG. 22B.

FIG. 23 depicts a Barker code sequence with length 13.

FIG. 24 shows the autocorrelation function of the Barker code of FIG. 23.

FIG. 25A depicts a Barker code of length 13 with a time-hopping period T₁.

FIG. 25B illustrates a Barker code of length 13 with a time-hopping period T₂.

FIG. 25C shows an example of a transmitted pulse with zero phase-shift.

FIG. 25D depicts an example of a transmitted pulse with a phase shift of π radians (i.e., 180°).

FIG. 26 shows a block diagram of a transmitter circuitry that uses transmitter code-circuitry according to the invention.

FIG. 27A depicts a more detailed block diagram of an embodiment of a transmitter circuitry that uses transmitter code-circuitry according to the invention.

FIG. 27B illustrates a more detailed block diagram of another embodiment of a transmitter circuitry that uses transmitter code-circuitry according to the invention.

FIG. 27C shows a more detailed block diagram of yet another embodiment of a transmitter circuitry that uses transmitter code-circuitry according to the invention.

FIG. 27D shows a more detailed block diagram of an additional embodiment of a transmitter circuitry that uses transmitter code-circuitry according to the invention.

FIG. 28 depicts a block diagram of a receiver circuitry that uses receiver code-circuitry according to the invention.

FIG. 29A illustrates a radar system that includes a transmitter code-circuitry and a receiver code-circuitry according to the invention.

FIG. 29B shows a radar system that includes a transmitter/receiver code-circuitry according to the invention.

FIG. 30 illustrates a communication system that comprises a transmitter circuitry and a receiver circuitry. The transmitter circuitry includes a transmitter code-circuitry according to the invention. The receiver circuitry includes a receiver code-circuitry according to the invention.

FIG. 31A shows a communication system that comprises a pair of transceiver circuitries. Each transceiver circuitry includes a transmitter/receiver code-circuitry according to the invention.

FIG. 31B depicts a communication system that comprises a pair of transceiver circuitries. Each transceiver circuitry includes a transmitter code-circuitry and a receiver code-circuitry according to the invention.

### DETAILED DESCRIPTION OF THE INVENTION

Recent advances in communications technology have enabled an emerging, revolutionary ultra wideband technology (UWB) called impulse radio communications systems (hereinafter called impulse radio). To better understand the benefits of impulse radio to the present invention, the following review of impulse radio follows. Impulse radio was first fully described in a series of patents, including U.S. Pat. Nos. 4,641,317 (issued Feb. 3, 1987), 4,813,057 (issued Mar. 14, 1989), 4,979,186 (issued Dec. 18, 1990) and 5,363,108 (issued Nov. 8, 1994) to Larry W. Fullerton. A second generation of impulse radio patents includes U.S. Pat. Nos. 5,677,927 (issued Oct. 14, 1997), 5,687,169 (issued Nov. 11, 1997) and co-pending application Ser. No. 08/761,602 (filed Dec. 6, 1996) to Fullerton et al.

Uses of impulse radio systems are described in U.S. patent application Ser. No. 09/332,502, entitled, “System and Method for Intrusion Detection using a Time Domain Radar Array” and U.S. patent application Ser. No. 09/332,503, entitled, “Wide Area Time Domain Radar Array” both filed on Jun. 14, 1999 and both of which are assigned to the assignee of the present invention. All of the above patent documents are incorporated herein by reference.

Impulse Radio Basics

Impulse radio refers to a radio system based on short, low duty cycle pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Most waveforms with enough bandwidth approximate a Gaussian shape to a useful degree.

Impulse radio can use many types of modulation, including AM, time shift (also referred to as pulse position) and M-ary versions. The time shift method has simplicity and power output advantages that make it desirable. In this document, the time shift method is used as an illustrative example. However, someone skilled in the art will recognize that alternative modulation approaches may be used in replace of or in combination with time shift modulation approach without departing from the scope of the invention. In particular, amplitude modulation, especially antipodal amplitude modulation is useful and convenient in implementing instances of the invention.

In impulse radio communications, the pulse-to-pulse interval can be varied on a pulse-by-pulse basis by two components: an information component and a code component. Generally, conventional spread spectrum systems employ codes to spread the normally narrow band information signal over a relatively wide band of frequencies. A conventional spread spectrum receiver correlates these signals to retrieve the original information signal. Unlike conventional spread spectrum systems, in impulse radio communications codes are not needed for energy spreading because the monocycle pulses themselves have an inherently wide bandwidth. Instead, codes are used for channelization, energy smoothing in the frequency domain, resistance to interference, and reducing the interference potential to nearby receivers.

The impulse radio receiver is typically a direct conversion receiver with a cross correlator front end which coherently converts an electromagnetic pulse train of monocycle pulses to a baseband signal in a single stage. The baseband signal is the basic information signal for the impulse radio communications system. It is often found desirable to include a subcarrier with the baseband signal to help reduce the effects of amplifier drift and low frequency noise. The subcarrier that is typically implemented alternately reverses modulation according to a known pattern at a rate faster than the data rate. This same pattern is used to reverse the process and restore the original data pattern just before detection. This method permits alternating current (AC) coupling of stages, or equivalent signal processing to eliminate direct current (DC) drift and errors from the detection process. This method is described in detail in U.S. Pat. No. 5,677,927 to Fullerton et al.

In impulse radio communications utilizing time shift modulation, each data bit typically time position modulates many pulses of the periodic timing signal. In impulse radio communications utilizing antipodal amplitude modulation, an information component comprising one or more bits of data typically amplitude modulates a sequence of pulses comprising a periodic timing signal with a plus one or minus one to represent binary data. This yields a modulated, coded timing signal that comprises a train of pulses for each single data bit. The impulse radio receiver integrates multiple pulses to recover the transmitted information.

Waveforms

Impulse radio refers to a radio system based on short, low duty cycle pulses. In the widest bandwidth embodiment, the resulting waveform approaches one cycle per pulse at the center frequency. In more narrow band embodiments, each pulse consists of a burst of cycles usually with some spectral shaping to control the bandwidth to meet desired properties such as out of band emissions or in-band spectral flatness, or time domain peak power or burst off-time attenuation.

For system analysis purposes, it is convenient to model the desired waveform in an ideal sense to provide insight into the optimum behavior for detail design guidance. One such waveform model that has been useful is the Gaussian monocycle as shown in FIG. 1A. This waveform is representative of the transmitted pulse produced by a step function into an ultra-wideband antenna. The basic equation normalized to a peak value of 1 is as follows:

$${f}_{mono} ( t ) = \sqrt{e} ( \frac{t}{σ} ) {ⅇ}^{\frac{- {t}^{2}}{2 {σ}^{2}}}$$

Where,

σ is a time scaling parameter,

t is time,

fₘₒₙₒ(t) is the waveform voltage, and

e is the natural logarithm base.

The frequency domain spectrum of the above waveform is shown in FIG. 1B. The corresponding equation is:

$${F}_{mono} ( f ) = {( 2 π )}^{\frac{3}{2}} σ f {ⅇ}^{- 2 {( π σ f )}^{2}}$$

The center frequency (f_{c}), or frequency of peak spectral density is:

$${f}_{c} = \frac{1}{2 π σ}$$

These pulses, or bursts of cycles, may be produced by methods described in the patents referenced above or by other methods that are known to one of ordinary skill in the art. Any practical implementation will deviate from the ideal mathematical model by some amount. In fact, this deviation from ideal may be substantial and yet yield a system with acceptable performance. This is especially true for microwave implementations, where precise waveform shaping is difficult to achieve. These mathematical models are provided as an aid to describing ideal operation and are not intended to limit the invention. In Tact, any burst of cycles that adequately fills a given bandwidth and has an adequate on-off attenuation ratio for a given application will serve the purpose of this invention.

A Pulse Train

Impulse radio systems can deliver one or more data bits per pulse; however, impulse radio systems more typically use pulse trains, not single pulses, for each data bit. As described in detail in the following example system, the impulse radio transmitter produces and outputs a train of pulses for each bit of information.

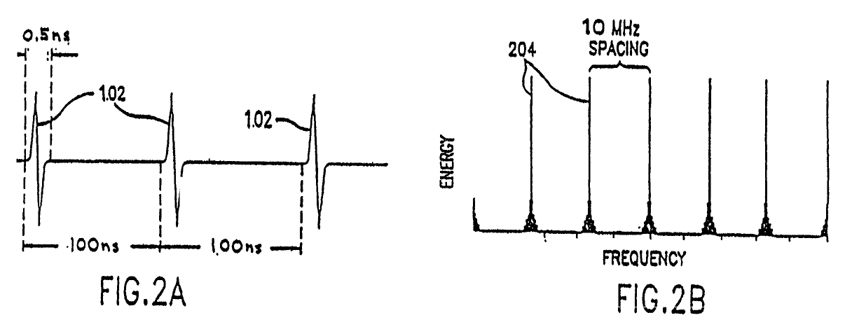

Prototypes have been built which have pulse repetition frequencies including 0.7 and 10 megapulses per second (Mpps, where each megapulse is 10⁶ pulses). FIGS. 2A and 2B are illustrations of the output of a typical 10 Mpps system with uncoded, unmodulated, 0.5 nanosecond (ns) pulses 102. FIG. 2A shows a time domain representation of this sequence of pulses 102. FIG. 2B, which shows 60 MHZ at the center of the spectrum for the waveform of FIG. 2A, illustrates that the result of the pulse train in the frequency domain is to produce a spectrum comprising a set of lines 204 spaced at the frequency of the 10 Mpps pulse repetition rate. When the full spectrum is shown, the envelope of the line spectrum follows the curve of the single pulse spectrum 104 of FIG. 1B. For this simple uncoded case, the power of the pulse train is spread among roughly two hundred comb lines. Each comb line thus has a small fraction of the total power and presents much less of an interference problem to a receiver sharing the band.

It can also be observed from FIG. 2A that impulse radio systems typically have very low average duty cycles resulting in average power significantly lower than peak power. The duty cycle of the signal in the present example is 0.5%, based on a 0.5 ns pulse in a 100 ns interval.

Coding for Energy Smoothing and Channelization

For high pulse rate systems, it may be necessary to more finely spread the spectrum than is achieved by producing comb lines. This may be done by non-uniformly positioning each pulse relative to its nominal position according to a code such as a pseudo random code.

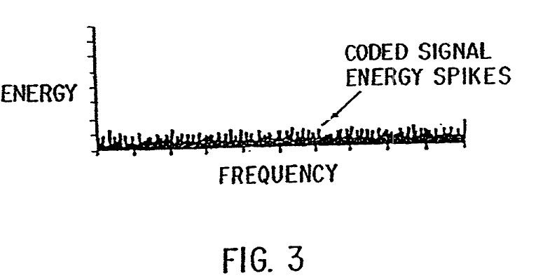

FIG. 3 is a plot illustrating the impact of a pseudo-noise (PN) code dither on energy distribution in the frequency domain (A pseudo-noise, or PN code is a set of time positions defining pseudo-random positioning for each pulse in a sequence of pulses). FIG. 3, when compared to FIG. 2B, shows that the impact of using a PN code is to destroy the comb line structure and spread the energy more uniformly. This structure typically has slight variations that are characteristic of the specific code used.

Coding also provides a method of establishing independent communication channels using impulse radio. Codes can be designed to have low cross correlation such that a pulse train using one code will seldom collide on more than one or two pulse positions with a pulses train using another code during any one data bit time. Since a data bit may comprise hundreds of pulses, this represents a substantial attenuation of the unwanted channel.

Modulation

Any aspect of the waveform can be modulated to convey information. Amplitude modulation, phase modulation, frequency modulation, time shift modulation and M-ary versions of these have been proposed. Both analog and digital forms have been implemented. Of these, digital time shift modulation has been demonstrated to have various advantages and can be easily implemented using a correlation receiver architecture.

Digital time shift modulation can be implemented by shifting the coded time position by an additional amount (that is, in addition to code dither) in response to the information signal. This amount is typically very small relative to the code shift. In a 10 Mpps system with a center frequency of 2 GHz., for example, the code may command pulse position variations over a range of 100 ns; whereas, the information modulation may only deviate the pulse position by 150 Ps.

Thus, in a pulse train of n pulses, each pulse is delayed a different amount from its respective time base clock position by an individual code delay amount plus a modulation amount, where n is the number of pulses associated with a given data symbol digital bit.

Modulation further smoothes the spectrum, minimizing structure in the resulting spectrum.

Reception and Demodulation

Clearly, if there were a large number of impulse radio users within a confined area, there might be mutual interference. Further, while coding minimizes that interference, as the number of users rises, the probability of an individual pulse from one user's sequence being received simultaneously with a pulse from another user's sequence increases. Impulse radios are able to perform in these environments, in part, because they do not depend on receiving every pulse. The impulse radio receiver performs a correlating, synchronous receiving function (at the RF level) that uses a statistical sampling and combining of many pulses to recover the transmitted information.

Impulse radio receivers typically integrate from 1 to 1000 or more pulses to yield the demodulated output. The optimal number of pulses over which the receiver integrates is dependent on a number of variables, including pulse rate, bit rate, interference levels, and range.

Interference Resistance

Besides channelization and energy smoothing, coding also makes impulse radios highly resistant to interference from all radio communications systems, including other impulse radio transmitters. This is critical as any other signals within the band occupied by an impulse signal potentially interfere with the impulse radio. Since there are currently no unallocated bands available for impulse systems, they must share spectrum with other conventional radio systems without being adversely affected. The code helps impulse systems discriminate between the intended impulse transmission and interfering transmissions from others.

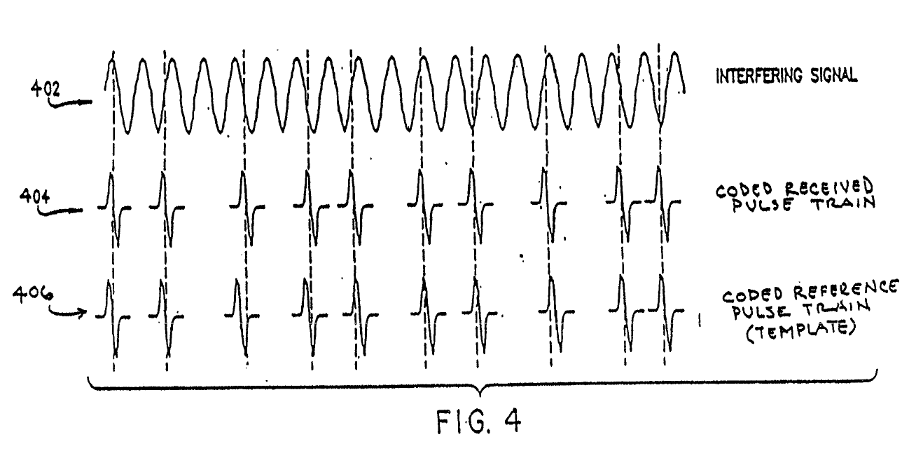

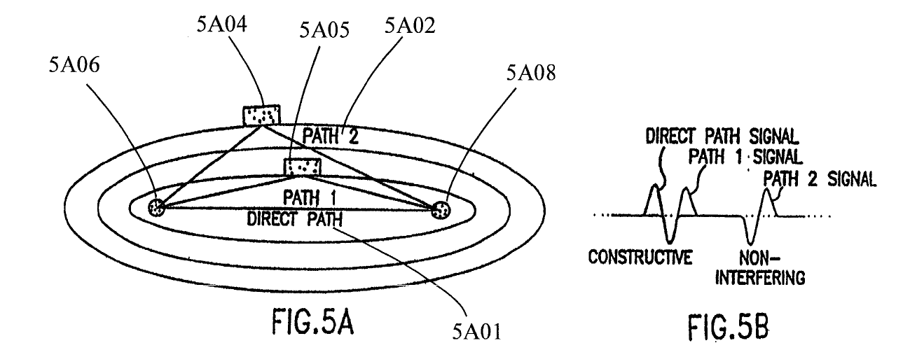

FIG. 4 illustrates the result of a narrow band sinusoidal interference signal 402 overlaying an impulse radio signal 404. At the impulse radio receiver, the input to the cross correlation would include the narrow band signal 402, as well as the received ultra-wideband impulse radio signal 404. The input is sampled by the cross correlator with a code dithered template signal 406. Without coding, the cross correlation would sample the interfering signal 402 with such regularity that the interfering signals could cause significant interference to the impulse radio receiver. However, when the transmitted impulse signal is encoded with the code dither (and the impulse radio receiver template signal 406 is synchronized with that identical code dither) the correlation samples the interfering signals non-uniformly. The samples from the interfering signal add incoherently, increasing roughly according to square root of the number of samples integrated; whereas, the impulse radio samples add coherently, increasing directly according to the number of samples integrated. Thus, integrating over many pulses overcomes the impact of interference.

Processing Gain Impulse radio is resistant to interference because of its large processing gain. For typical spread spectrum systems, the definition of processing gain, which quantifies the decrease in channel interference when wide-band communications are used, is the ratio of the bandwidth of the channel to the bit rate of the information signal. For example, a direct sequence spread spectrum system with a 10 KHz information bandwidth and a 10 MHz channel bandwidth yields a processing gain of 1000 or 30 dB. However, far greater processing gains are achieved by impulse radio systems, where the same 10 KHz information bandwidth is spread across a much greater 2 GHz channel bandwidth, resulting in a theoretical processing gain of 200,000 or 53 dB.

Capacity

It has been shown theoretically, using signal to noise arguments, that thousands of simultaneous voice channels are available to an impulse radio system as a result of the exceptional processing gain, which is due to the exceptionally wide spreading bandwidth.

For a simplistic user distribution, with N interfering users of equal power equidistant from the receiver, the total interference signal to noise ratio as a result of these other users can be described by the following equation:

$${V}_{tot}^{2} = \frac{N {σ}^{2}}{\sqrt{Z}}$$

Where

V²ₜₒₜ is the total interference signal to noise ratio variance, at the receiver;

N is the number of interfering users;

σ² is the signal to noise ratio variance resulting from one of the interfering signals with a single pulse cross correlation; and

Z is the number of pulses over which the receiver integrates to recover the modulation.

This relationship suggests that link quality degrades gradually as the number of simultaneous users increases. It also shows the advantage of integration gain. The number of users that can be supported at the same interference level increases by the square root of the number of pulses integrated.

Multipath and Propagation

One of the striking advantages of impulse radio is its resistance to multipath fading effects. Conventional narrow band systems are subject to multipath through the Rayleigh fading process, where the signals from many delayed reflections combine at the receiver antenna according to their seemingly random relative phases. This results in possible summation or possible cancellation, depending on the specific propagation to a given location. This situation occurs where the direct path signal is weak relative to the multipath signals, which represents a major portion of the potential coverage of a radio system. In mobile systems, this results in wild signal strength fluctuations as a function of distance traveled, where the changing mix of multipath signals results in signal strength fluctuations for every few feet of travel.

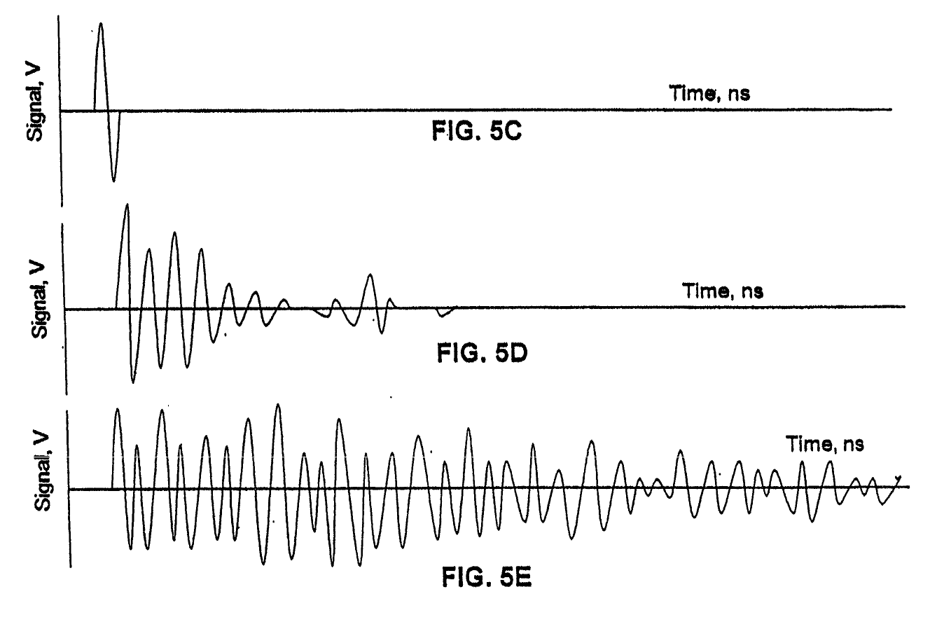

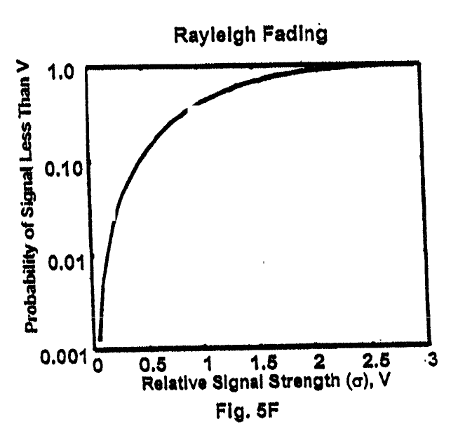

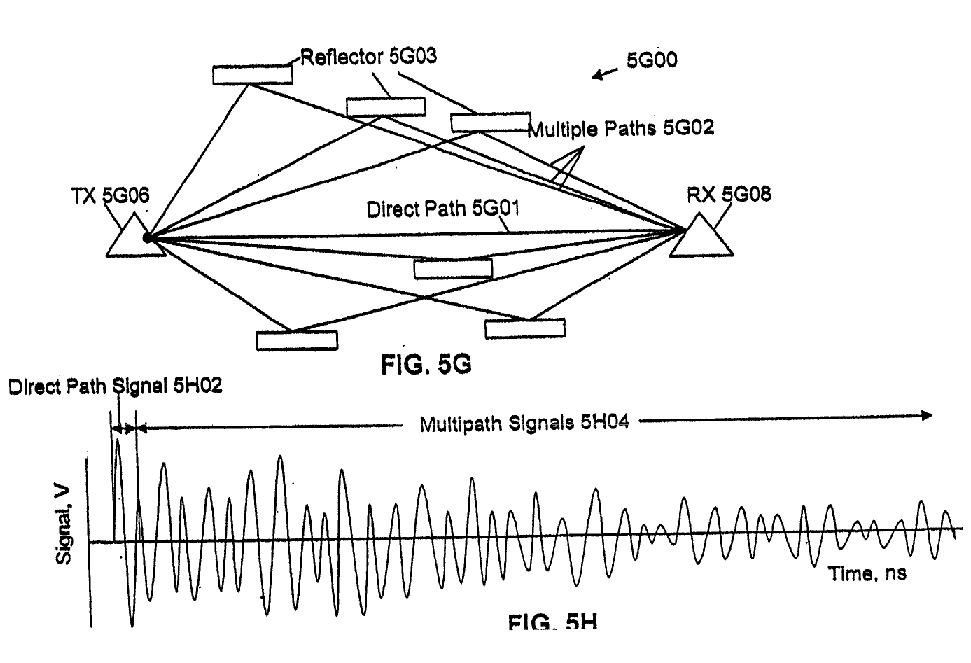

Impulse radios, however, can be substantially resistant to these effects. Impulses arriving from delayed multipath reflections typically arrive outside of the correlation time and thus can be ignored. This process is described in detail with reference to FIGS. 5A and 5B. In FIG. 5A, three propagation paths are shown. The direct path representing the straight-line distance between the transmitter and receiver is the shortest. Path 1 represents a grazing multipath reflection, which is very close to the direct path. Path 2 represents a distant multipath reflection. Also shown are elliptical (or, in space, ellipsoidal) traces that represent other possible locations for reflections with the same time delay.

FIG. 5B represents a time domain plot of the received waveform from this multipath propagation configuration. This figure comprises three doublet pulses as shown in FIG. 1A. The direct path signal is the reference signal and represents the shortest propagation time. The path 1 signal is delayed slightly and actually overlaps and enhances the signal strength at this delay value. Note that the reflected waves are reversed in polarity. The path 2 signal is delayed sufficiently that the waveform is completely separated from the direct path signal. If the correlator template signal is positioned at the direct path signal, the path 2 signal will produce no response. It can be seen that only the multipath signals resulting from very close reflectors have any effect on the reception of the direct path signal. The multipath signals delayed less than one quarter wave (one quarter wave is about 1.5 inches, or 3.75 cm at 2 GHz center frequency) are the only multipath signals that can attenuate the direct path signal. This region is equivalent to the first Fresnel zone familiar to narrow band systems designers. Impulse radio, however, has no further nulls in the higher order Fresnel zones. The ability to avoid the highly variable attenuation from multipath gives impulse radio significant performance advantages.

FIG. 5A illustrates a typical multipath situation, such as in a building, where there are many reflectors 5A04, 5A05 and multiple propagation paths 5A02, 5A01. In this figure, a transmitter TX 5A06 transmits a signal that propagates along the multiple propagation paths 5A02, 5A04 to receiver RX 5A08, where the multiple reflected signals are combined at the antenna.

FIG. 5B illustrates a resulting typical received composite pulse waveform resulting from the multiple reflections and multiple propagation paths 5A01, 5A02. In this figure, the direct path signal 5A01 is shown as the first pulse signal received. The multiple reflected signals (“multipath signals”, or “multipath”) comprise the remaining response as illustrated.

FIGS. 5C, 5D, and 5E represent the received signal from a TM-UWB transmitter in three different multipath environments. These figures are not actual signal plots, but are hand drawn plots approximating typical signal plots. FIG. 5C illustrates the received signal in a very low multipath environment. This may occur in a building where the receiver antenna is in the middle of a room and is one meter from the transmitter. This may also represent signals received from some distance, such as 100 meters, in an open field where there are no objects to produce reflections. In this situation, the predominant pulse is the first received pulse and the multipath reflections are too weak to be significant. FIG. 5D illustrates an intermediate multipath environment. This approximates the response from one room to the next in a building. The amplitude of the direct path signal is less than in FIG. 5C and several reflected signals are of significant amplitude. FIG. 5E approximates the response in a severe multipath environment such as: propagation through many rooms; from corner to corner in a building;

within a metal cargo hold of a ship; within a metal truck trailer; or within an intermodal shipping container. In this scenario, the main path signal is weaker than in FIG. 5D. In this situation, the direct path signal power is small relative to the total signal power from the reflections.

An impulse radio receiver can receive the signal and demodulate the information using either the direct path signal or any multipath signal peak having sufficient signal to noise ratio. Thus, the impulse radio receiver can select the strongest response from among the many arriving signals. In order for the signals to cancel and produce a null at a given location, dozens of reflections would have to be cancelled simultaneously and precisely while blocking the direct path—a highly unlikely scenario. This time separation of multipath signals together with time resolution and selection by the receiver permit a type of time diversity that virtually eliminates cancellation of the signal. In a multiple correlator rake receiver, performance is further improved by collecting the signal power from multiple signal peaks for additional signal to noise performance.

Where the system of FIG. 5B is a narrow band system and the delays are small relative to the data bit time, the received signal is a sum of a large number of sine waves of random amplitude and phase. In the idealized limit, the resulting envelope amplitude has been shown to follow a Rayleigh cumulative probability distribution as follows:

p(S_{DB})=1−exp(−10^{S}^{_{dB}}^{/10})

where S_{dB} is the instantaneous signal level expressed in as a decibel ratio to the average multipath power, and p(S_{dB}) is the probability that the signal less than S_{dB}. From the equation: p(−10 dB)=0.1 hence, 10% of the time the signal is 10 or more dB below the average multipath power.

This distribution is shown in FIG. 5G. It can be seen in FIG. 5G that approximately 10% of the time, the signal is more than 10 dB below the average multipath power. This suggests that 10 dB fade margin is needed to provide 90% link availability. Values of fade margin from 10 to 40 dB have been suggested for various narrow band systems, depending on the required reliability. This characteristic has been the subject of much research and can be partially improved by such techniques as antenna and frequency diversity, but these techniques result in additional complexity and cost.

In a high multipath environment such as inside homes, offices, warehouses, automobiles, trailers, shipping containers, or outside in the urban canyon or other situations where the propagation is such that the received signal is primarily scattered energy, impulse radio, according to the present invention, can avoid the Rayleigh fading mechanism that limits performance of narrow band systems. This is illustrated in FIGS. 5G and 5H in a transmit and receive system in a high multipath environment 5G00, wherein the transmitter 5G06 transmits to receiver 5G08 with the signals reflecting off reflectors 5G03 which form multipaths 5G02. The direct path is illustrated as 5G01 with the signal graphically illustrated at 5H02, with the vertical axis being the signal strength in volts and horizontal axis representing time in nanoseconds. Multipath signals are graphically illustrated at 5H04.

Distance Measurement

Important for positioning, impulse systems can measure distances to extremely fine resolution because of the absence of ambiguous cycles in the waveform. Narrow band systems, on the other hand, are limited to the modulation envelope and cannot easily distinguish precisely which RF cycle is associated with each data bit because the cycle-to-cycle amplitude differences are so small they are masked by link or system noise. Since the impulse radio waveform has no multi-cycle ambiguity, this allows positive determination of the waveform position to less than a wavelength—potentially, down to the noise floor of the system. This time position measurement can be used to measure propagation delay to determine link distance, and once link distance is known, to transfer a time reference to an equivalently high degree of precision. The inventors of the present invention have built systems that have shown the potential for centimeter distance resolution, which is equivalent to about 30 ps of time transfer resolution. See, for example, commonly owned, co-pending application Ser. No. 09/045,929, filed Mar. 23, 1998, titled “Ultrawide-Band Position Determination System and Method”, and Ser. No. 09/083,993, filed May 26, 1998, titled “System and Method for Distance Measurement by In-phase and Quadrature Signals in a Radio System,” both of which are incorporated herein by reference.

In addition to the methods articulated above, impulse radio technology along with Time Division Multiple Access algorithms and Time Domain packet radios can achieve geo-positioning capabilities in a radio network. This geo-positioning method allows ranging to occur within a network of radios without the necessity of a full duplex exchange among every pair of radios.

Exemplary Transceiver Implementation

Transmitter

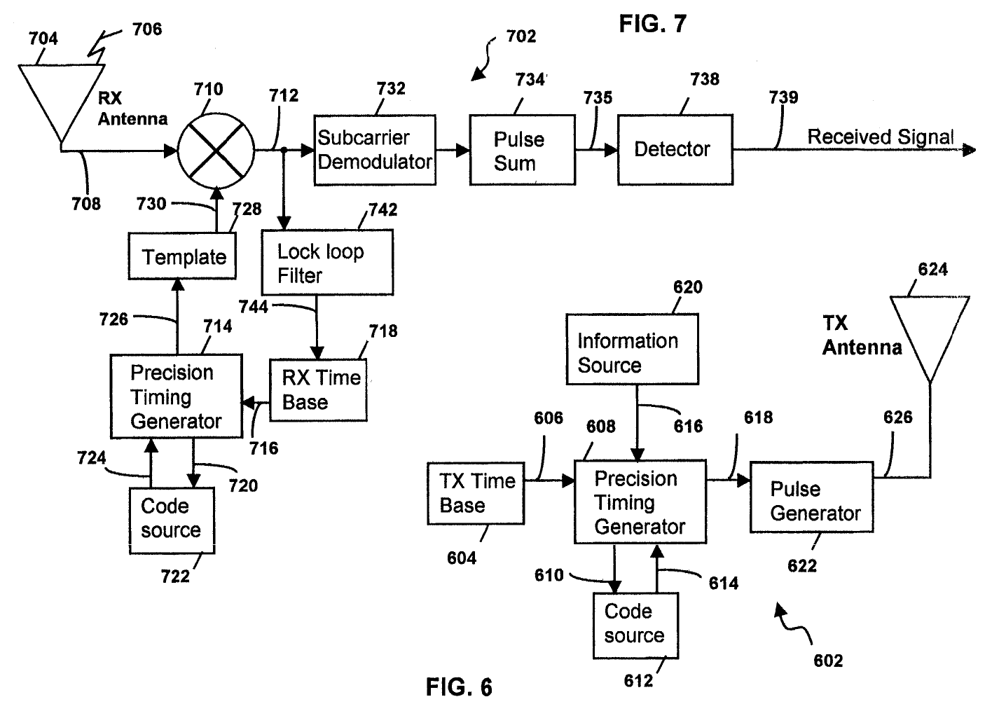

An exemplary embodiment of an impulse radio transmitter 602 of an impulse radio communication system having one subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter, on the order of picoseconds (ps). The voltage control to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614 together with an internally generated subcarrier signal (which is optional) and an information signal 616 to generate a modulated, coded timing signal 618. The code source 612 comprises a storage device such as a random access memory (RAM), read only memory (ROM), or the like, for storing suitable codes and for outputting the PN codes as a code signal 614. Alternatively, maximum length shift registers or other computational means can be used to generate the codes.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger to generate output pulses. The output pulses are sent to a transmit antenna 624 via a transmission line 626 coupled thereto. The output pulses are converted into propagating electromagnetic pulses by the transmit antenna 624. In the present embodiment, the electromagnetic pulses are called the emitted signal, and propagate to an impulse radio receiver 702, such as shown in FIG. 7, through a propagation medium, such as air, in a radio frequency embodiment. In a preferred embodiment, the emitted signal is wide-band or ultra-wideband, approaching a monocycle pulse as in FIG. 1A. However, the emitted signal can be spectrally modified by filtering of the pulses. This bandpass filtering will cause each monocycle pulse to have more zero crossings (more cycles,) in the time domain. In this case, the impulse radio receiver can use a similar waveform as the template signal in the cross correlator for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710 via a receiver transmission line, coupled to the receive antenna 704, and producing a baseband output 712.

The receiver 702 also includes a precision timing generator 714, which receives a periodic timing signal 716 from a receiver time base 718. This time base 718 is adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 ideally comprises a multiplier followed by a short term integrator to sum the multiplier product over the pulse interval.

The output of the correlator 710 is coupled to a subcarrier demodulator 732, which demodulates the subcarrier information signal from the subcarrier. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to determine an output signal 739 representing the digital state of the output voltage of sample and hold 736.

The baseband signal 712 is also input to a low-pass filter 742 (also referred to as lock loop filter 742). A control loop comprising the low-pass filter 742, time base 718, precision timing generator 714, template generator 728, and correlator 710 is used to generate an error signal 744. The error signal 744 provides adjustments to the adjustable time base 718 to time position the periodic timing signal 726 in relation to the position of the received, signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

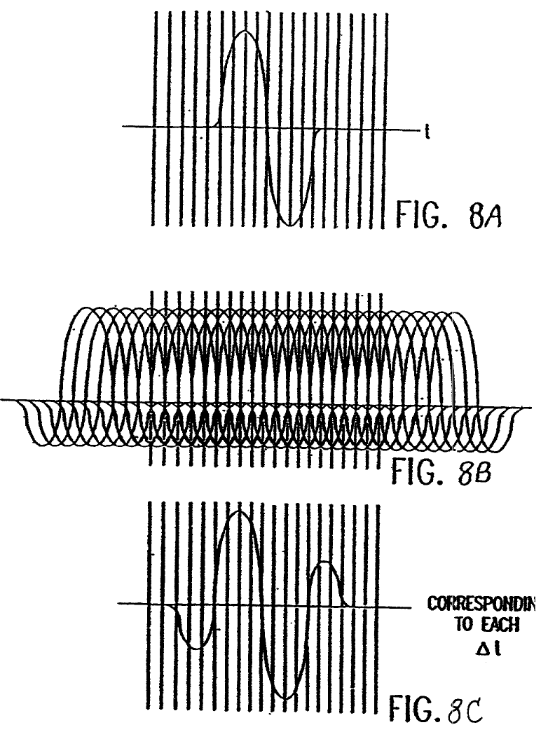

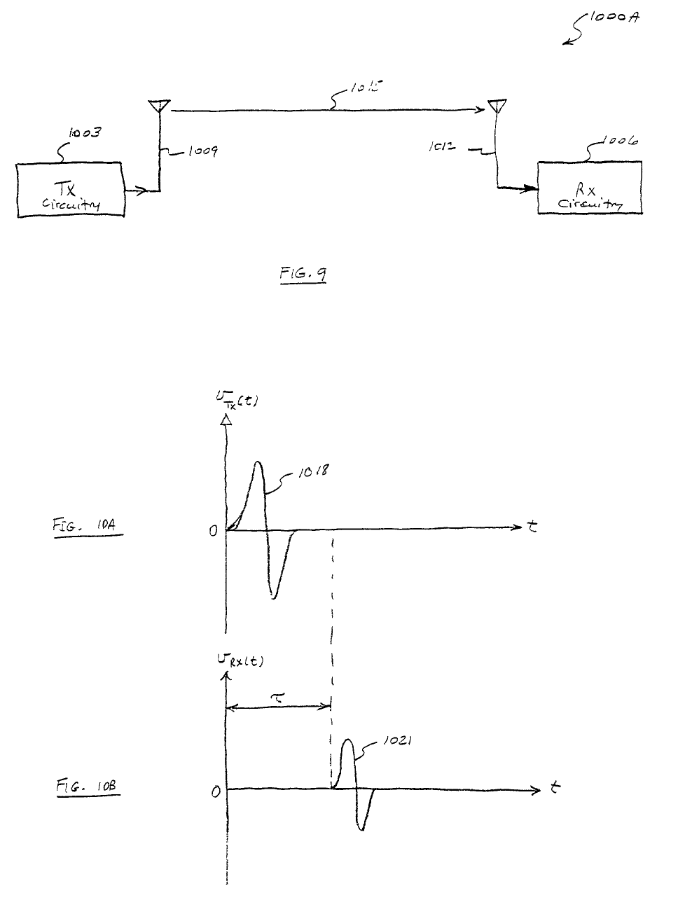

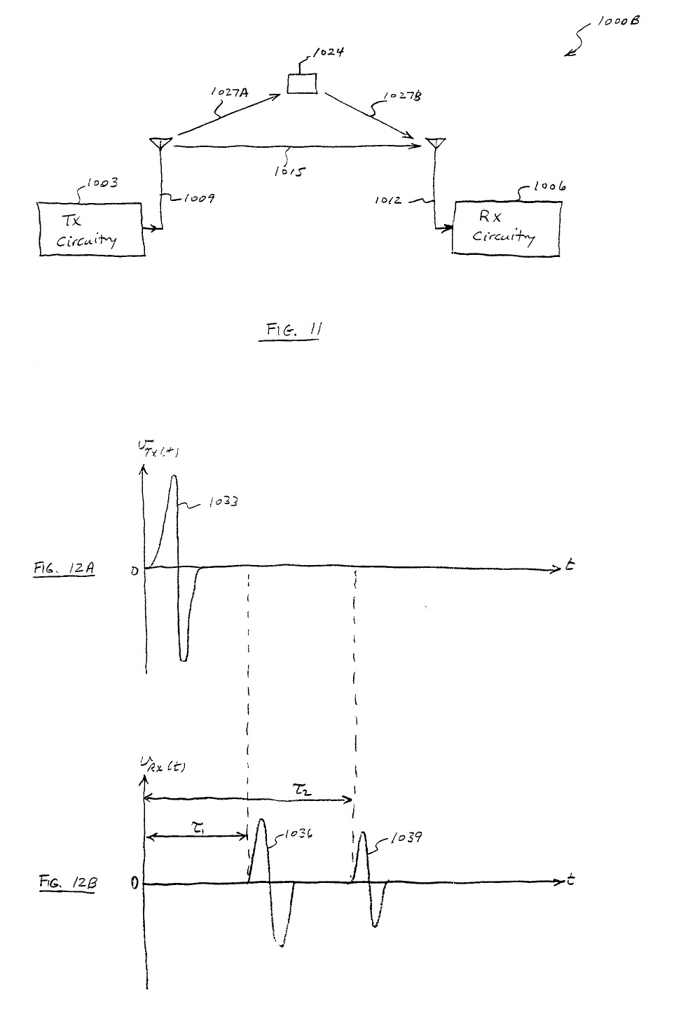

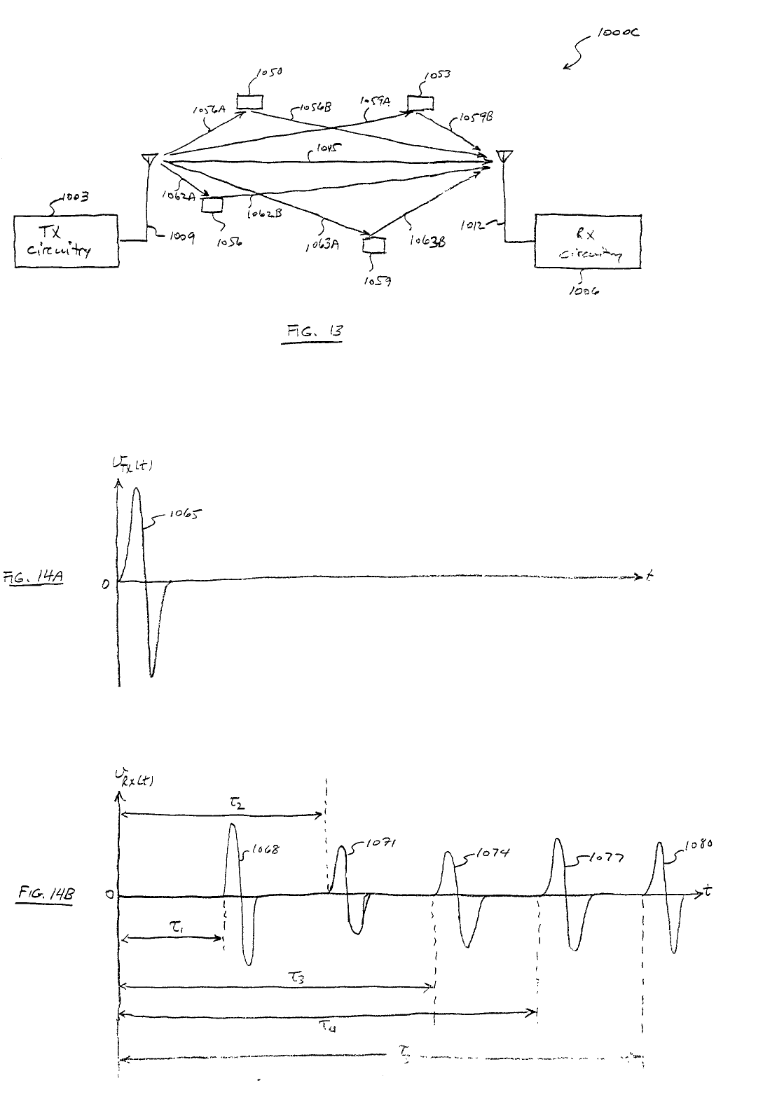

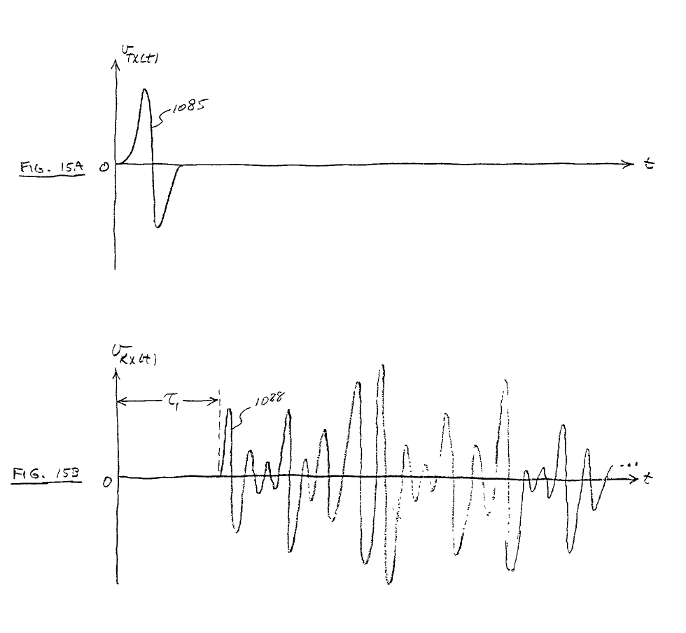

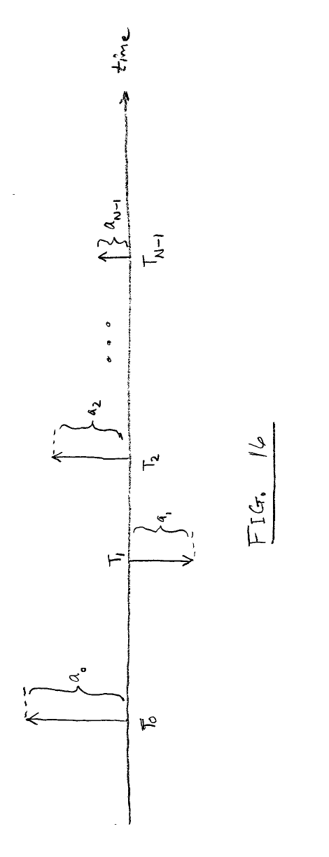

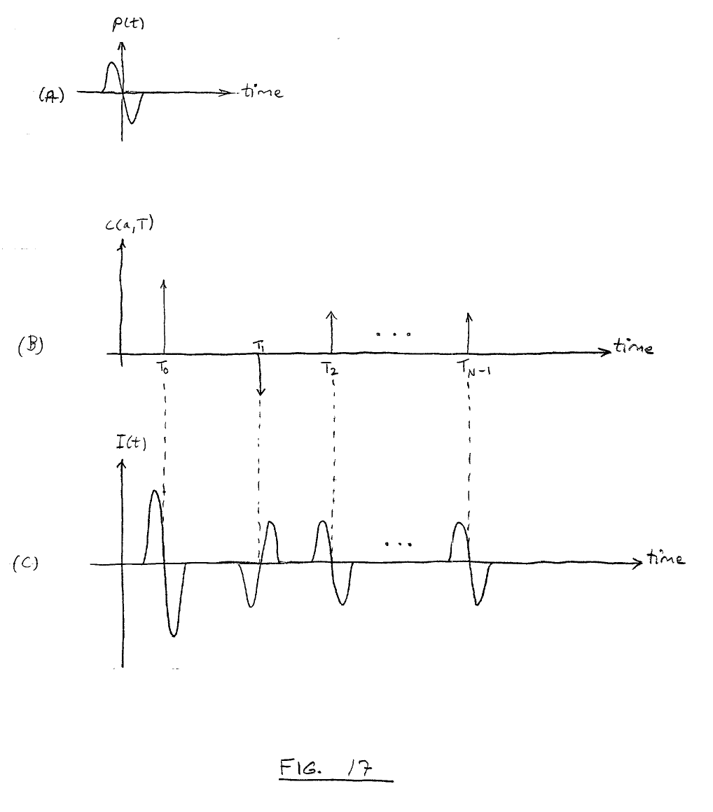

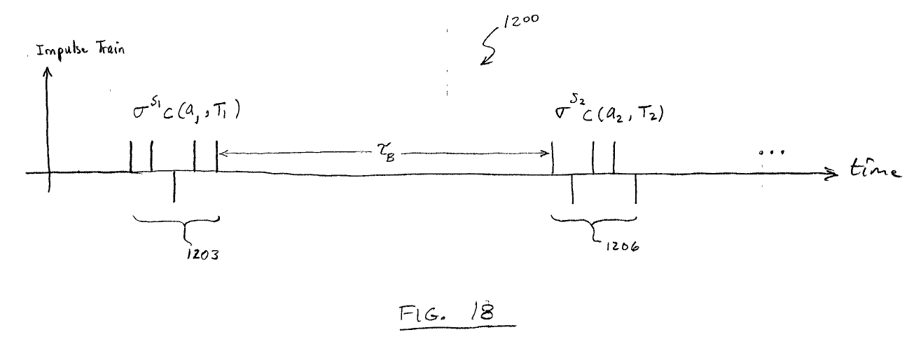

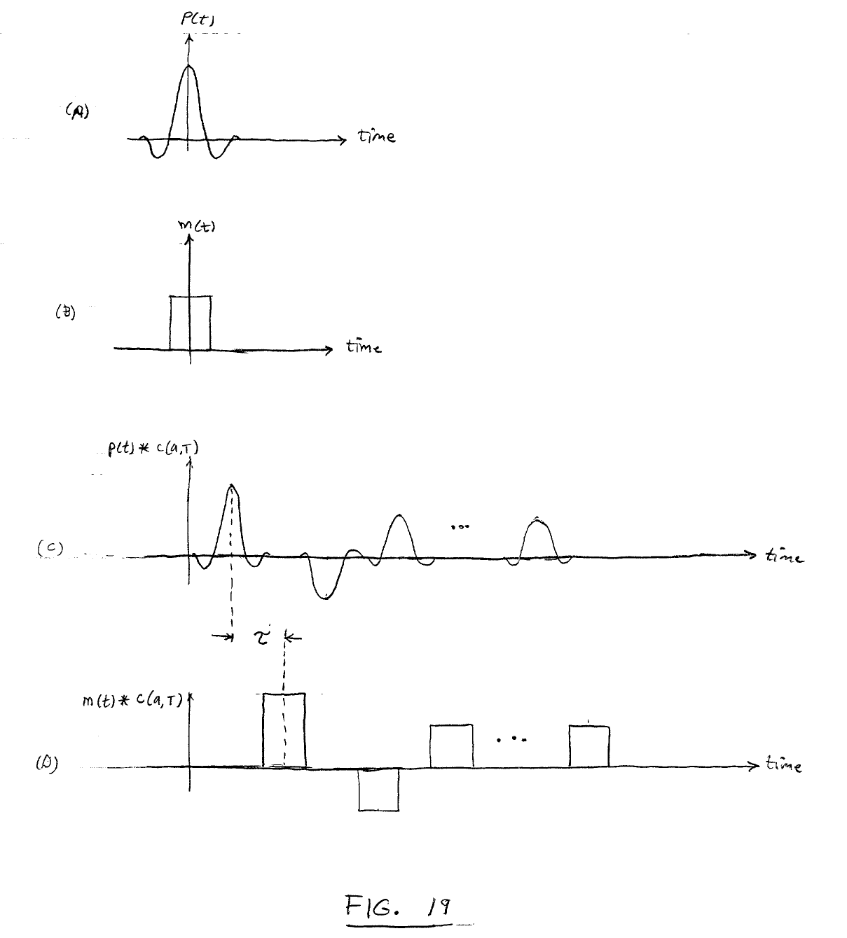

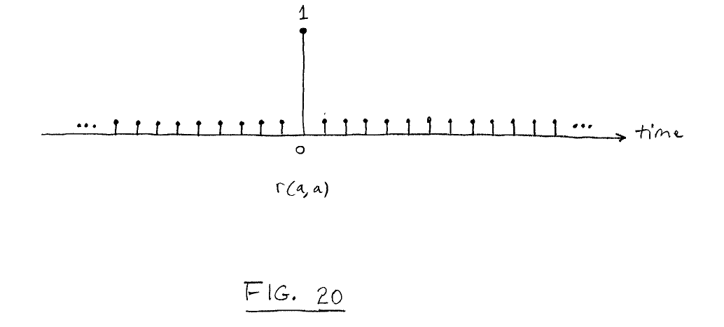

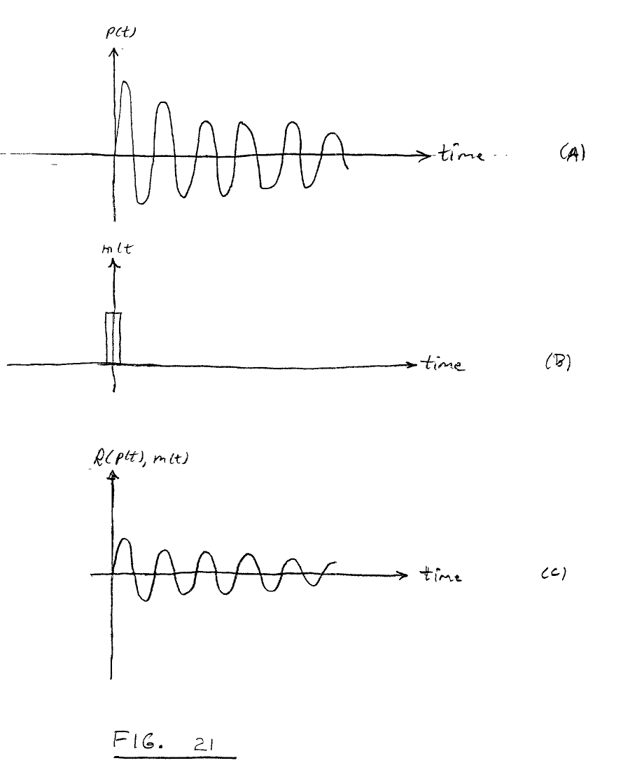

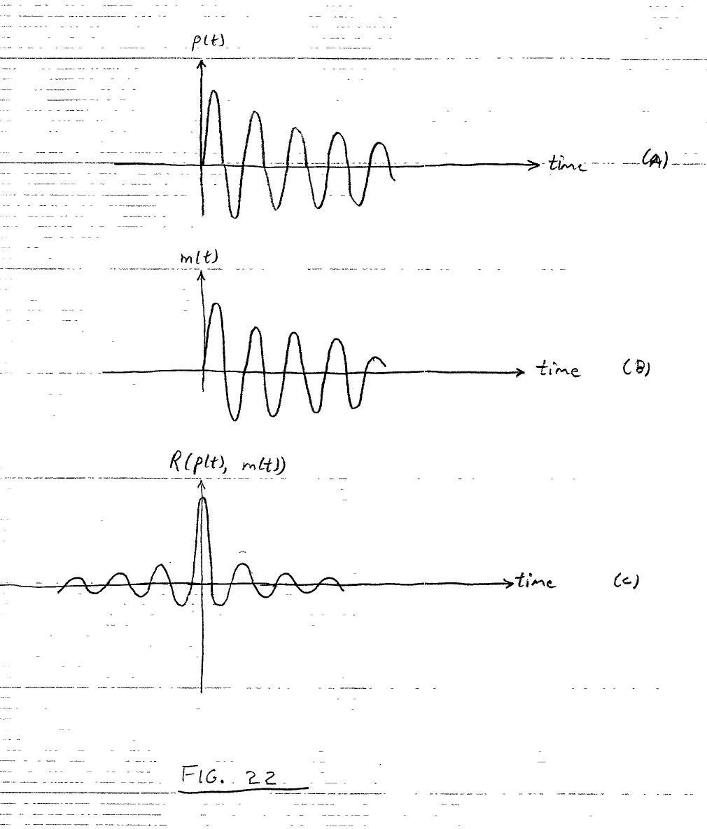

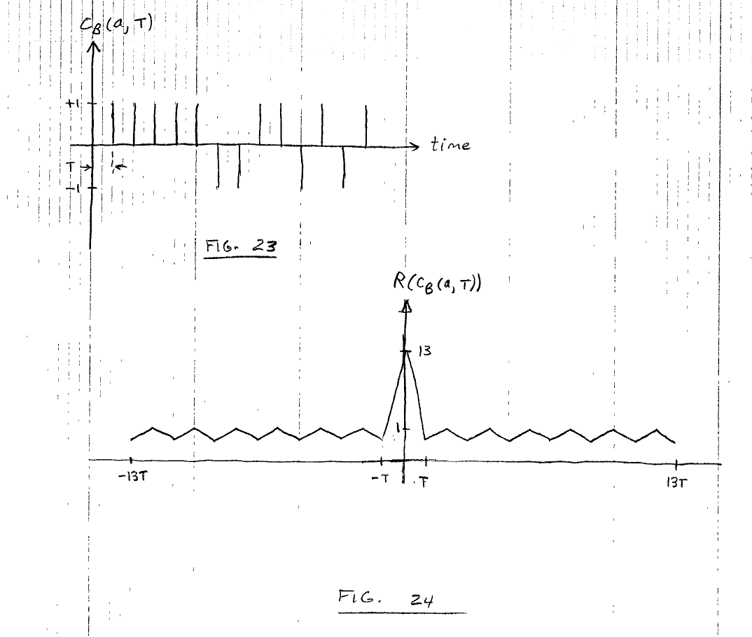

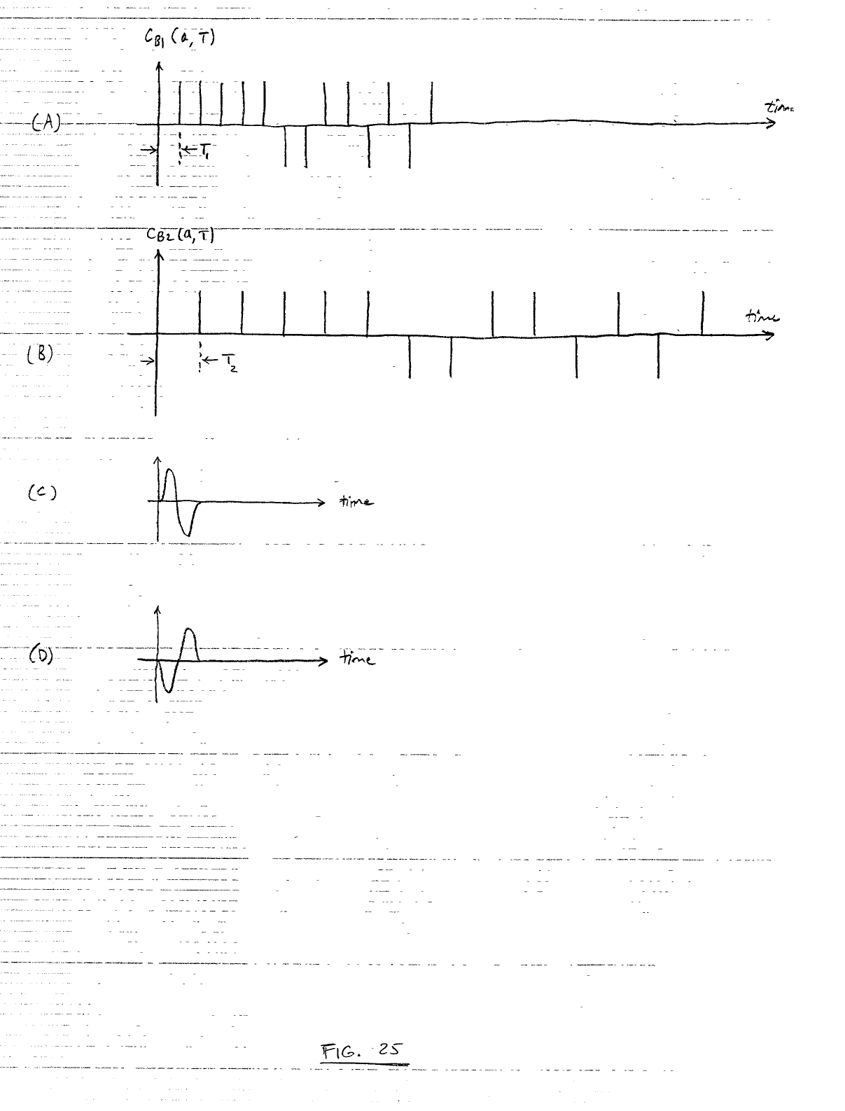

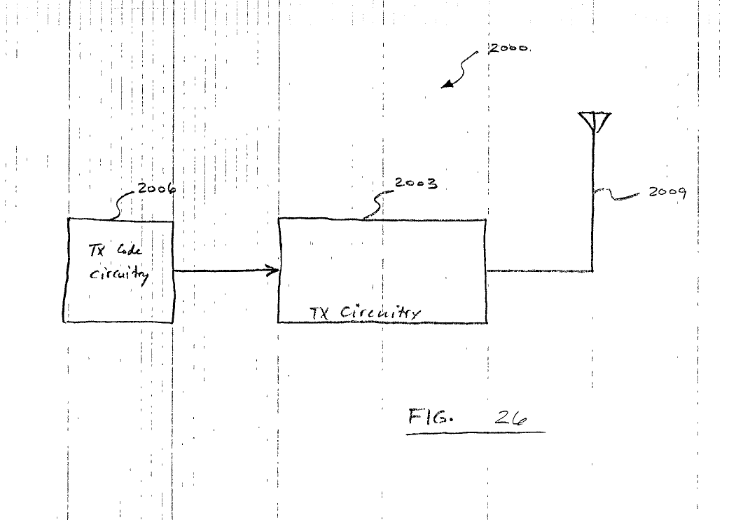

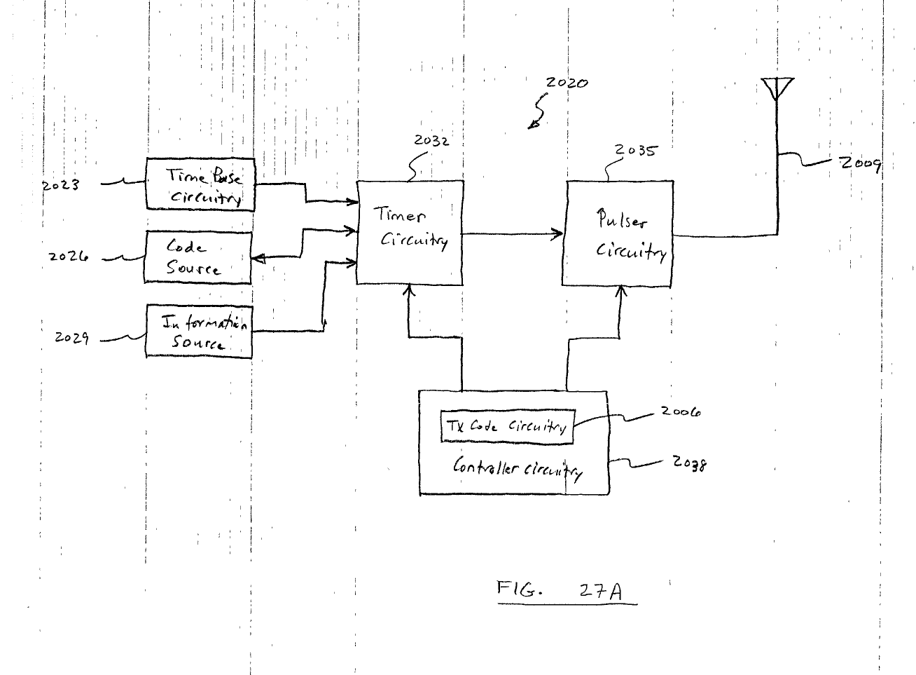

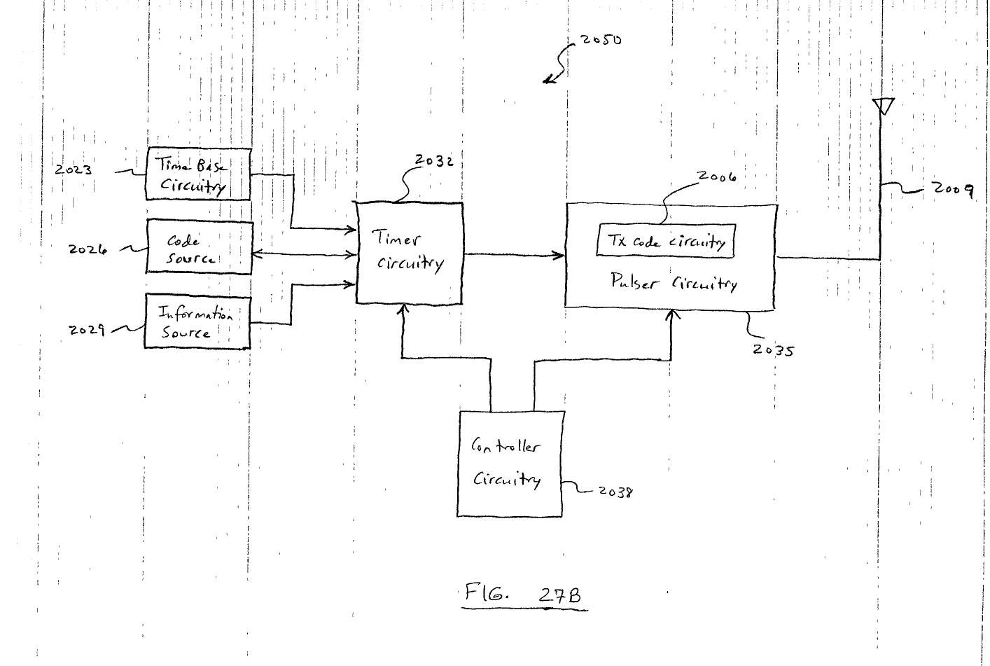

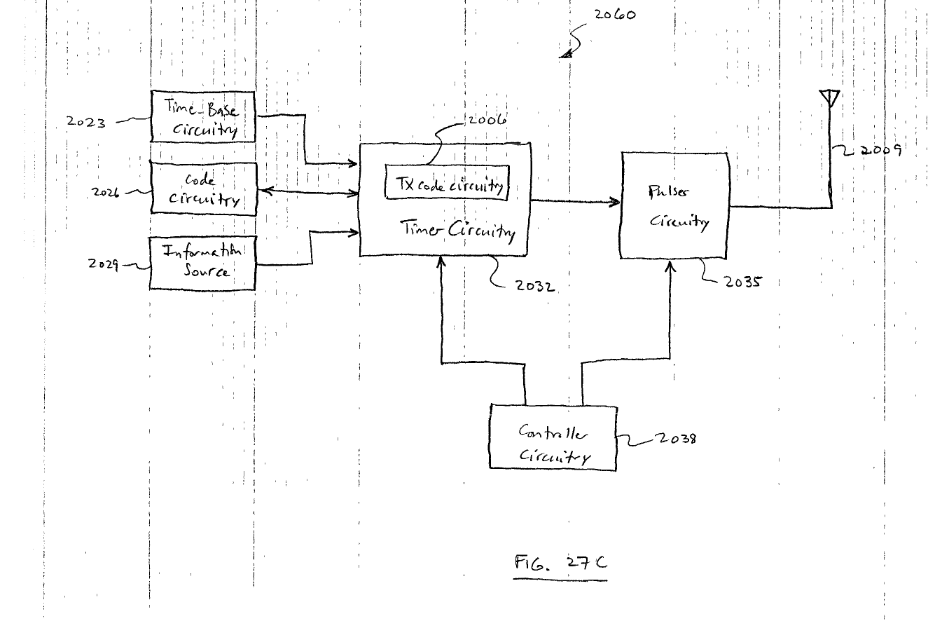

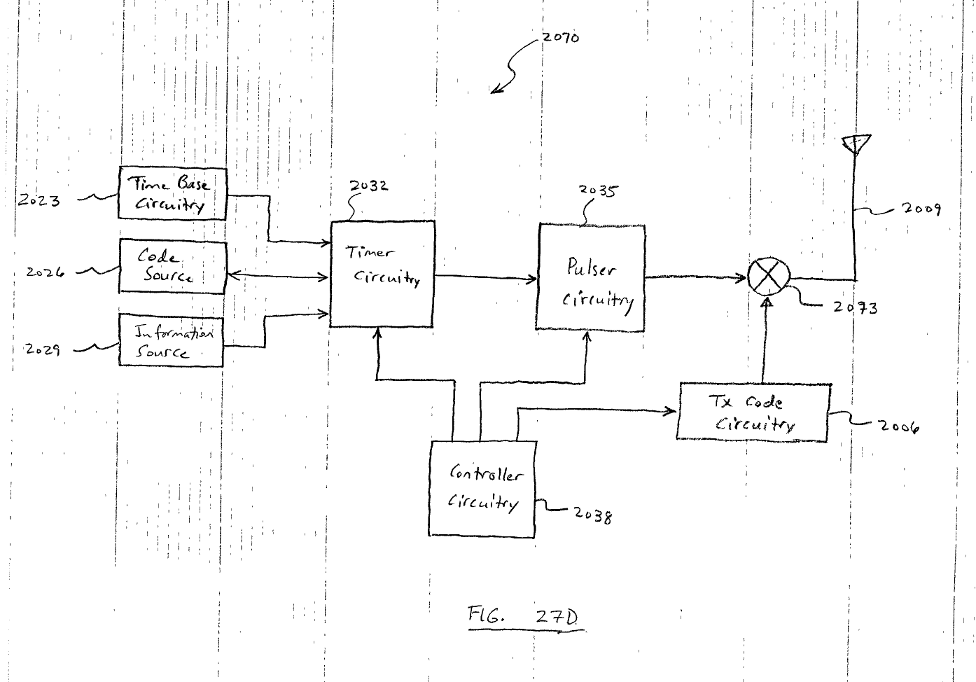

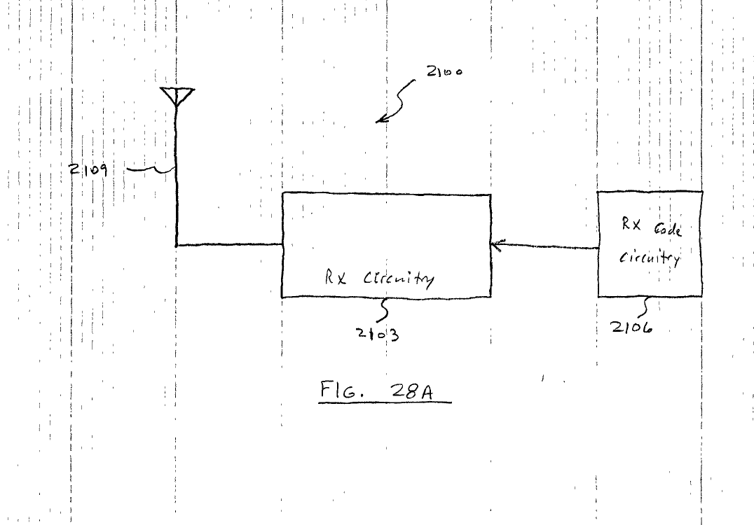

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the correlator (multiplier and short time integrator) for each of the time offsets of FIG. 8B. Thus, this graph does not show a waveform that is a function of time, but rather a function of time-offset. For any given pulse received, there is only one corresponding point that is applicable on this graph. This is the point corresponding to the time offset of the template signal used to receive that pulse. Further examples and details of precision timing can be found described in U.S. Pat. No. 5,677,927, and commonly owned co-pending application Ser. No. 09/146,524, filed Sep. 3, 1998, titled “Precision Timing Generator System and Method” both of which are incorporated herein by reference.

Recent Advances in Impulse Radio Communication

Modulation Techniques

To improve the placement and modulation of pulses and to find new and improved ways that those pulses transmit information, various modulation techniques have been developed. The modulation techniques articulated above as well as the recent modulation techniques invented and summarized below are incorporated herein by reference.

FLIP Modulation

An impulse radio communications system can employ FLIP modulation techniques to transmit and receive flip modulated impulse radio signals. Further, it can transmit and receive flip with shift modulated (also referred to as quadrature flip time modulated (QFTM)) impulse radio signals. Thus, FLIP modulation techniques can be used to create two, four, or more different data states.

Flip modulators include an impulse radio receiver with a time base, a precision timing generator, a template generator, a delay, first and second correlators, a data detector and a time base adjustor. The time base produces a periodic timing signal that is used by the precision timing generator to produce a timing trigger signal. The template generator uses the timing trigger signal to produce a template signal. A delay receives the template signal and outputs a delayed template signal. When an impulse radio signal is received, the first correlator correlates the received impulse radio signal with the template signal to produce a first correlator output signal, and the second correlator correlates the received impulse radio signal with the delayed template signal to produce a second correlator output signal. The data detector produces a data signal based on at least the first correlator output signal. The time base adjustor produces a time base adjustment signal based on at least the second correlator output signal. The time base adjustment signal is used to synchronize the time base with the received impulse radio signal.

For greater elaboration of FLIP modulation techniques, the reader is directed to the patent application entitled, “Apparatus, System and Method for FLIP Modulation in an Impulse Radio Communication System”, Ser. No. 09/537,692, filed Mar. 29, 2000 and assigned to the assignee of the present invention. This patent application is incorporated herein by reference.

Vector Modulation

Vector Modulation is a modulation technique which includes the steps of generating and transmitting a series of time-modulated pulses, each pulse delayed by one of four predetermined time delay periods and representative of at least two data bits of information, and receiving and demodulating the series of time-modulated pulses to estimate the data bits associated with each pulse. The apparatus includes an impulse radio transmitter and an impulse radio receiver.

The transmitter transmits the series of time-modulated pulses and includes a transmitter time base, a time delay modulator, a code time modulator, an output stage, and a transmitting antenna. The receiver receives and demodulates the series of time-modulated pulses using a receiver time base and two correlators, one correlator designed to operate after a pre-determined delay with respect to the other correlator. Each correlator includes an integrator and a comparator, and may also include an averaging circuit that calculates an average output for each correlator, as well as a track and hold circuit for holding the output of the integrators. The receiver further includes an adjustable time delay circuit that may be used to adjust the pre-determined delay between the correlators in order to improve detection of the series of time-modulated pulses.

For greater elaboration of Vector modulation techniques, the reader is directed to the patent application entitled, “Vector Modulation System and Method for Wideband Impulse Radio Communications”, Ser. No. 09/169,765, filed Dec. 9, 1999 and assigned to the assignee of the present invention. This patent application is incorporated herein buy reference.

Receivers

Because of the unique nature of impulse radio receivers several modifications have been recently made to enhance system capabilities.

Multiple Correlator Receivers

Multiple correlator receivers utilize multiple correlators that precisely measure the impulse response of a channel and wherein measurements can extend to the maximum communications range of a system, thus, not only capturing ultra-wideband propagation waveforms, but also information on data symbol statistics. Further, multiple correlators enable rake acquisition of pulses and thus faster acquisition, tracking implementations to maintain lock and enable various modulation schemes. Once a tracking correlator is synchronized and locked to an incoming signal, the scanning correlator can sample the received waveform at precise time delays relative to the tracking point. By successively increasing the time delay while sampling the waveform, a complete, time-calibrated picture of the waveform can be collected.

For greater elaboration of utilizing multiple correlator techniques, the reader is directed to the patent application entitled, “System and Method of using Multiple Correlator Receivers in an Impulse Radio System”, Ser. No. 09/537,264, filed Mar. 29, 2000 and assigned to the assignee of the present invention. This patent application is incorporated herein by reference.

Fast Locking Mechanisms

Methods to improve the speed at which a receiver can acquire and lock onto an incoming impulse radio signal have been developed. In one approach, a receiver comprises an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in detail in U.S. Pat. No. 5,832,035 to Fulleiton, incorporated herein by reference.

In another approach, a receiver obtains a template pulse train and a received impulse radio signal. The receiver compares the template pulse train and the received impulse radio signal to obtain a comparison result. The system performs a threshold check on the comparison result. If the comparison result passes the threshold check, the system locks on the received impulse radio signal.

The system may also perform a quick check, a synchronization check, and/or a command check of the impulse radio signal. For greater elaboration of this approach, the reader is directed to the patent application entitled, “Method and System for Fast Acquisition of Ultra Wideband Signals”, Ser. No. 09/538,292, filed Mar. 29, 2000 and assigned to the assignee of the present invention. This patent application is incorporated herein by reference.

Baseband Signal Converters

A receiver has been developed which includes a baseband signal converter device and combines multiple converter circuits and an RF amplifier in a single integrated circuit package. Each converter circuit includes an integrator circuit that integrates a portion of each RF pulse during a sampling period triggered by a timing pulse generator. The integrator capacitor is isolated by a pair of Schottky diodes connected to a pair of load resistors. A current equalizer circuit equalizes the current flowing through the load resistors when the integrator is not sampling. Current steering logic transfers load current between the diodes and a constant bias circuit depending on whether a sampling pulse is present.

For greater elaboration of utilizing baseband signal converters, the reader is directed to the patent application entitled, “Baseband Signal Converter for a Wideband Impulse Radio Receiver”, Ser. No. 09/356,384, filed Jul. 16, 1999 and assigned to the assignee of the present invention. This patent application is incorporated herein by reference.

Power Control and Interference

Power Control

Power control improvements have been invented with respect to impulse radios. The power control systems comprise a first transceiver that transmits an impulse radio signal to a second transceiver. A power control update is calculated according to a performance measurement of the signal received at the second transceiver. The transmitter power of either transceiver, depending on the particular embodiment, is adjusted according to the power control update. Various performance measurements are employed according to the current invention to calculate a power control update, including bit error rate, signal-to-noise ratio, and received signal strength, used alone or in combination. Interference is thereby reduced, which is particularly important where multiple impulse radios are operating in close proximity and their transmissions interfere with one another. Reducing the transmitter power of each radio to a level that produces satisfactory reception increases the total number of radios that can operate in an area without saturation. Reducing transmitter power also increases transceiver efficiency.

For greater elaboration of utilizing baseband signal converters, the reader is directed to the patent application entitled, “System and Method for Impulse Radio Power Control”, Ser. No. 09/332,501, filed Jun. 14, 1999 and assigned to the assignee of the present invention. This patent application is incorporated herein by reference.

Mitigating Effects of Interference

To assist in mitigating interference to impulse radio systems a methodology has been invented. The method comprises the steps of: (a) conveying the message in packets; (b) repeating conveyance of selected packets to make up a repeat package; and (c) conveying the repeat package a plurality of times at a repeat period greater than twice the occurrence period of the interference. The communication may convey a message from a proximate transmitter to a distal receiver, and receive a message by a proximate receiver from a distal transmitter. In such a system, the method comprises the steps of: (a) providing interference indications by the distal receiver to the proximate transmitter; (b) using the interference indications to determine predicted noise periods; and (c) operating the proximate transmitter to convey the message according to at least one of the following: (1) avoiding conveying the message during noise periods; (2) conveying the message at a higher power during noise periods; (3) increasing error detection coding in the message during noise periods; (4) re-transmitting the message following noise periods; (5) avoiding conveying the message when interference is greater than a first strength; (6) conveying the message at a higher power when the interference is greater than a second strength; (7) increasing error detection coding in the message when the interference is greater than a third strength; and (8) retransmitting a portion of the message after interference has subsided to less than a predetermined strength.

For greater elaboration of mitigating interference to impulse radio systems, the reader is directed to the patent application entitled, “Method for Mitigating Effects of Interference in Impulse Radio Communication”, Ser. No. 09/587,033, filed Jun. 2, 1999 and assigned to the assignee of the present invention. This patent application is incorporated herein by reference.

Moderating Interference While Controlling Equipment

Yet another improvement to impulse radio includes moderating interference with impulse radio wireless control of an appliance; the control is affected by a controller remote from the appliance transmitting impulse radio digital control signals to the appliance. The control signals have a transmission power and a data rate. The method comprises the steps of: (a) in no particular order: (1) establishing a maximum acceptable noise value for a parameter relating to interfering signals; (2) establishing a frequency range for measuring the interfering signals; (b) measuring the parameter for the interference signals within the frequency range; and (c) when the parameter exceeds the maximum acceptable noise value, effecting an alteration of transmission of the control signals.

For greater elaboration of moderating interference while effecting impulse radio wireless control of equipment, the reader is directed to the patent application entitled, “Method and Apparatus for Moderating Interference While Effecting Impulse Radio Wireless Control of Equipment”, Ser. No. 09/586,163, filed Jun. 2, 1999 and assigned to the assignee of the present invention. This patent application is incorporated herein by reference.

Coding Advances

The improvements made in coding can directly improve the characteristics of impulse radio as used in the present invention. Specialized coding techniques may be employed to establish temporal and/or non-temporal pulse characteristics such that a pulse train will possess desirable properties. Coding methods for specifying temporal and non-temporal pulse characteristics are described in commonly owned, co-pending applications entitled “A Method and Apparatus for Positioning Pulses in Time”, Ser. No. 09/592,249, and “A Method for Specifying Non-Temporal Pulse Characteristics”, Ser. No. 09/592,250, both filed Jun. 12, 2000, and both of which are incorporated herein by reference. Essentially, a temporal or non-temporal pulse characteristic value layout is defined, an approach for mapping a code to the layout is specified, a code is generated using a numerical code generation technique, and the code is mapped to the defined layout per the specified mapping approach.

A temporal or non-temporal pulse characteristic value layout may be fixed or non-fixed and may involve value ranges, discrete values, or a combination of value ranges and discrete values. A value range layout specifies a range of values for a pulse characteristic that is divided into components that are each subdivided into subcomponents, which can be further subdivided, ad infinitum. In contrast, a discrete value layout involves uniformly or non-uniformly distributed discrete pulse characteristic values. A non-fixed layout (also referred to as a delta layout) involves delta values relative to some reference value such as the characteristic value of the preceding pulse. Fixed and non-fixed layouts, and approaches for mapping code element values to them, are described in co-owned, co-pending applications, entitled “Method for Specifying Pulse Characteristics using Codes”, Ser. No. 09/592,290 and “A Method and Apparatus for Mapping Pulses to a Non-Fixed Layout”, Ser. No. 09/591,691, both filed on Jun. 12, 2000 and both of which are incorporated herein by reference.

A fixed or non-fixed characteristic value layout may include one or more non-allowable regions within which a characteristic value of a pulse is not allowed. A method for specifying non-allowable regions to prevent code elements from mapping to non-allowed characteristic values is described in co-owned, co-pending application entitled “A Method for Specifying Non-Allowable Pulse Characteristics”, Ser. No. 09/592,289, filed Jun. 12, 2000 and incorporated herein by reference. A related method that conditionally positions pulses depending on whether or not code elements map to non-allowable regions is described in co-owned, co-pending application, entitled “A Method and Apparatus for Positioning Pulses Using a Layout having Non-Allowable Regions”, Ser. No. 09/592,248 and incorporated herein by reference.

Typically, a code consists of a number of code elements having integer or floating-point values. A code element value may specify a single pulse characteristic (e.g., pulse position in time) or may be subdivided into multiple components, each specifying a different pulse characteristic. For example, a code having seven code elements each subdivided into five components (c0-c4) could specify five different characteristics of seven pulses. A method for subdividing code elements into components is described in commonly owned, co-pending application entitled “Method for Specifying Pulse Characteristics using Codes”, Ser. No. 09/592,290, filed Jun. 12, 2000 previously referenced and again incorporated herein by reference. Essentially, the value of each code element or code element component (if subdivided) maps to a value range or discrete value within the defined characteristic value layout. If a value range layout is used an offset value is typically employed to specify an exact value within the value range mapped to by the code element or code element component.

The signal of a coded pulse train can be generally expressed:

$${S}_{tr}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} , {b}_{j}^{( k )} )$$

where k is the index of a transmitter, j is the index of a pulse within its pulse train, (−1)fⱼ(k), aⱼ(k), cⱼ(k), and bⱼ(k) are the coded polarity, amplitude, width, and waveform of the jth pulse of the kth transmitter, and Tⱼ(k) is the coded time shift of the jth pulse of the kth transmitter. Note that when a given non-temporal characteristic does not vary (i.e., remains constant for all pulses in the pulse train), the corresponding code element component is removed from the above expression and the non-temporal characteristic value becomes a constant in front of the summation sign.

Various numerical code generation methods can be employed to produce codes having certain correlation and spectral properties. Such codes typically fall into one of two categories: designed codes and pseudorandom codes.

A designed code may be generated using a quadratic congruential, hyperbolic congruential, linear congruential, Costas array or other such numerical code generation technique designed to generate codes guaranteed to have certain correlation properties. Each of these alternative code generation techniques has certain characteristics to be considered in relation to the application of the pulse transmission system employing the code. For example, Costas codes have nearly ideal autocorrelation properties but somewhat less than ideal cross-correlation properties, while linear congruential codes have nearly ideal cross-correlation properties but less than ideal autocorrelation properties. In some cases, design tradeoffs may require that a compromise between two or more code generation techniques be made such that a code is generated using a combination of two or more techniques. An example of such a compromise is an extended quadratic congruential code generation approach that uses two ‘independent’ operators, where the first operator is linear and the second operator is quadratic.

Accordingly, one, two, or more code generation techniques or combinations of such techniques can be employed to generate a code without departing from the scope of the invention.

A pseudorandom code may be generated using a computer's random number generator, binary shift-register(s) mapped to binary words, a chaotic code generation scheme, or another well-known technique. Such ‘random-like’ codes are attractive for certain applications since they tend to spread spectral energy over multiple frequencies while having ‘good enough’ correlation properties, whereas designed codes may have superior correlation properties but have spectral properties that may not be as suitable for a given application.

Computer random number generator functions commonly employ the linear congruential generation (LCG) method or the Additive Lagged-Fibonacci Generator (ALFG) method. Alternative methods include inversive congruential generators, explicit-inversive congruential generators, multiple recursive generators, combined LCGs, chaotic code generators, and Optimal Golomb Ruler (OGR) code generators. Any of these or other similar methods can be used to generate a pseudorandom code without departing from the scope of the invention, as will be apparent to those skilled in the relevant art.

Detailed descriptions of code generation and mapping techniques are included in a co-owned patent application entitled “A Method and Apparatus for Positioning Pulses in Time”, Attorney Docket #: 28549-165554, which is hereby incorporated by reference.

It may be necessary to apply predefined criteria to determine whether a generated code, code family, or a subset of a code is acceptable for use with a given UWB application. Criteria to consider may include correlation properties, spectral properties, code length, non-allowable regions, number of code family members, or other pulse characteristics. A method for applying predefined criteria to codes is described in co-owned, co-pending application, entitled “A Method and Apparatus for Specifying Pulse Characteristics using a Code that Satisfies Predefined Criteria”, Ser. No. 09/592,288, filed Jun. 12, 2000 and is incorporated herein by reference.

In some applications, it may be desirable to employ a combination of two or more codes. Codes may be combined sequentially, nested, or sequentially nested, and code combinations may be repeated. Sequential code combinations typically involve transitioning from one code to the next after the occurrence of some event. For example, a code with properties beneficial to signal acquisition might be employed until a signal is acquired, at which time a different code with more ideal channelization properties might be used. Sequential code combinations may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in desirable spectral properties. A method for applying code combinations is described in co-owned, co-pending application, entitled “A Method and Apparatus for Applying Codes Having Pre-Defined Properties”, Ser. No. 09/591,690, filed Jun. 12, 2000 which is incorporated herein by reference.

Novel Radio-Frequency Apparatus with Improved Pulse-Rate

This invention contemplates radio-frequency (RF) apparatus with improved pulse-rate (i.e., improved data throughput). The RF apparatus may comprise a radio transmitter, a radio receiver, a radio transceiver, a radar, etc. The RF apparatus according to the invention improves the pulse rate in pulse-transmission systems, preferably ultra-wideband or impulse-radio systems. To achieve the improved pulse-rate, the RF apparatus according to the invention use codes or code sequences that have certain characteristics, that is, their autocorrelation has a low side-lobe to main-lobe ratio. Barker sequences fall within that class of codes or code sequences.

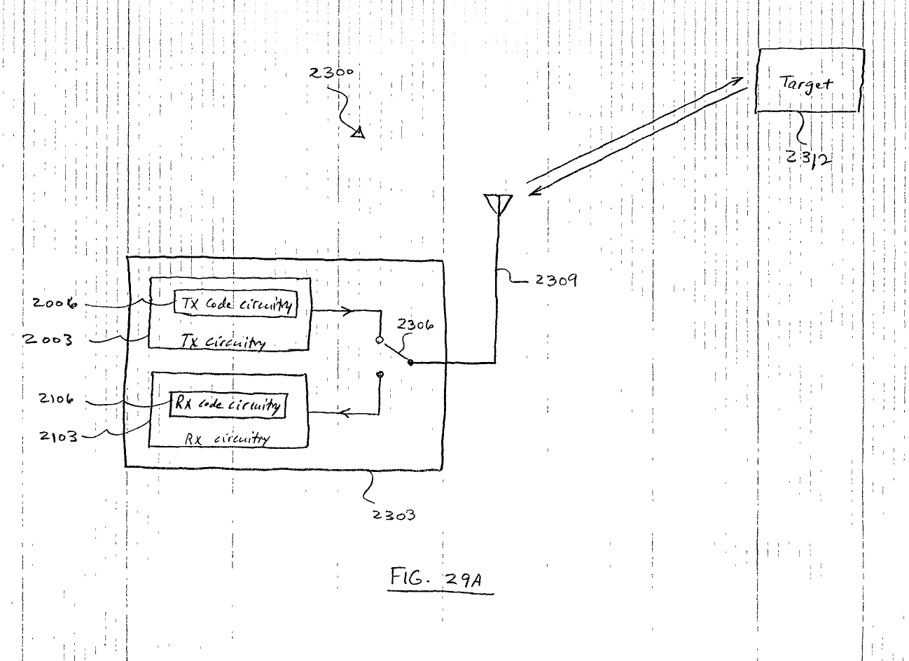

FIGS. 9-15 help to illustrate the effect of transient signals in RF apparatus operating in multipath environments. FIG. 9 shows a communication system 1000A that includes a transmitter circuitry 1003 and a receiver circuitry 1006. The transmitter circuitry 1003 transmits a pulse to the receiver circuitry 1006 via a transmitter antenna 1009. The transmitted pulse travels via a direct-path 1015 in a propagation medium. The receiver 1006 receives the transmitted signal via a receiver antenna 1012.

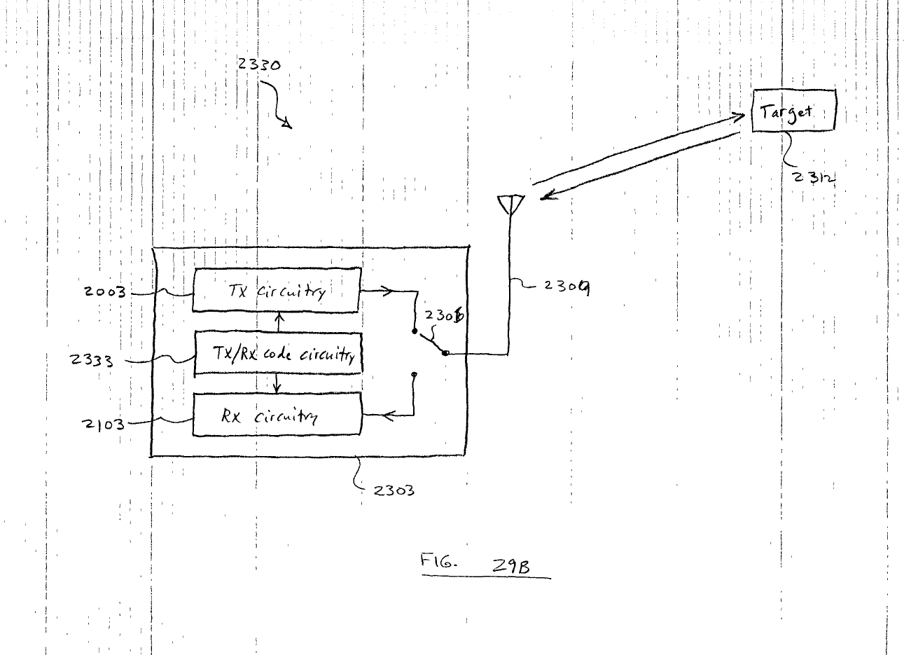

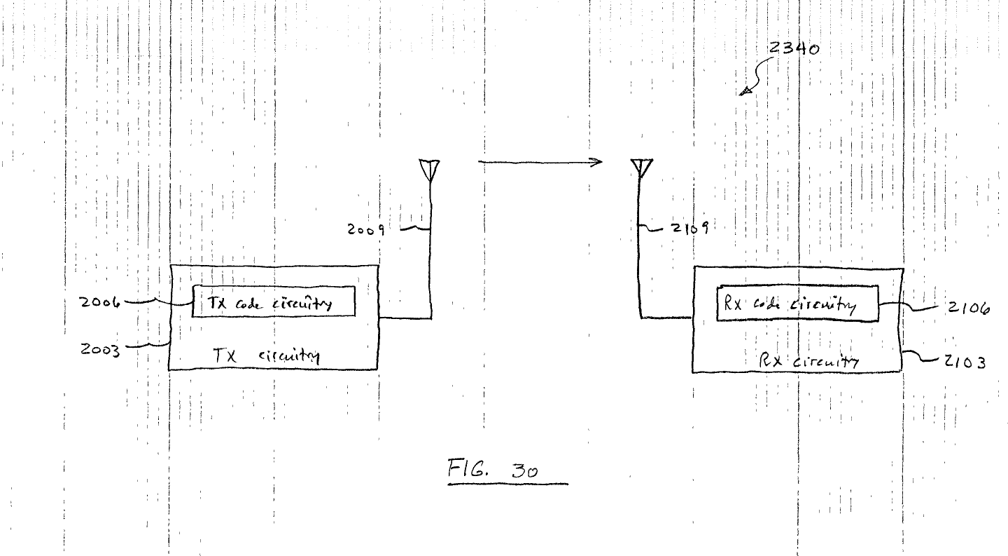

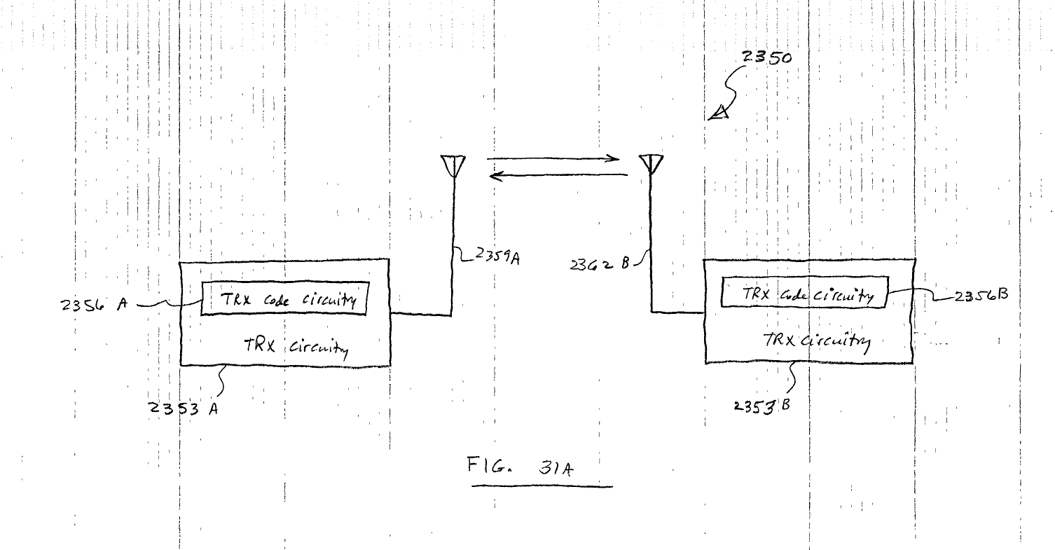

FIG. 10A shows the transmitted pulse 1018 as a function of time. The transmitted pulse 1018 preferably comprises an ultra-wideband pulse, or a Gaussian monocycle. FIG. 10B depicts the received pulse 1021. Note that the received pulse 1021 has a delay, shown as τ in FIG. 10B, with respect to the transmitted pulse 1018. The delay τ represents the propagation delay from the transmitter circuitry 1003 to the receiver circuitry 1006 along the direct path 1015. In other words, the transmitter circuitry 1003 provides the pulse to the transmitter antenna 1009. The transmitter antenna 1009 transmits a pulse at t=0, i.e., the origin on the horizontal axis on the graphs in FIGS. 10A and 10B. The transmitted pulse propagates along the direct path 1015 from the transmitter antenna 1009 to the receiver antenna 1012. After the delay τ, the transmitted pulse arrives at the receiver antenna 1012. The receiver antenna 1012 provides the received pulse to the receiver circuitry 1006. The receiver circuitry 1006 thereafter processes the received signal.

FIG. 11 illustrates a communication system 1000B that includes a transmitter circuitry 1003 and a receiver circuitry 1006. The transmitter circuitry transmits a pulse to the receiver circuitry 1006 via a transmitter antenna 1009. The transmitted pulse propagates via a direct path 1015 in a propagation medium. The receiver 1006 receives the transmitted signal via a receiver antenna 1012. The propagation environment in FIG. 11 includes also an object 1024. The object 1024 may comprise a wall, a building, an obstruction, an object in a room, or the like.

Unlike the system in FIG. 9, in the system of FIG. 1 the receiver circuitry 1006 receives two signals. FIG. 12A shows the transmitted pulse 1033 as a function of time. The transmitted pulse 1033 preferably comprises an ultra-wideband pulse, or a Gaussian monocycle. FIG. 12B depicts two received pulses 1036 and 1039. A direct-path pulse 1036 corresponds to the signal that propagates along the direct path 1015. The direct-path signal 1035 arrives first at the receiver antenna 1012 and, therefore, constitutes the first arriving pulse. The pulse 1036 reaches the receiver antenna after a delay shown as τ₁ in FIG. 12B. The delay τ₁ represents the propagation delay from the transmitter circuitry 1003 to the receiver circuitry 1006 along the direct-path 1015, as described above.

The transmitted pulse also propagates to the object 1024 along a path 1027A. The pulse interacts with the object (e.g., reflects from the object) and thereafter propagates to the receiver antenna 1012 along a path 1027B. This second pulse 1039 arrives at the receiver antenna 1012 after a delay shown as τ₂ in FIG. 12B. The delay τ₂ represents the propagation delay from the transmitter circuitry 1003 to the receiver circuitry 1006 along the path 1027A and the path 1027B.

FIG. 13 illustrates a communication system 1000C that includes a transmitter circuitry 1003 and a receiver circuitry 1006. The transmitter circuitry transmits a pulse to the receiver circuitry 1006 via a transmitter antenna 1009. The transmitted pulse preferably comprises an ultra-wideband pulse, or a Gaussian monocycle. The transmitted pulse propagates via a direct path 1015 in a propagation medium. The receiver 1006 receives the transmitted signal via a receiver antenna 1012. The propagation environment in FIG. 13 includes also four objects 1050, 1053, 1056, and 1059, respectively. Each of the four objects 1050, 1053, 1056, and 1059 may comprise a wall, a building, an obstruction, or the like. Thus, the receiver circuitry 1006 receives five signals. One of the five signals comprises the direct-path signal. The other four signals result from the interaction of the transmitted pulse with the objects 1050, 1053, 1056, and 1059.

In addition to the direct-path 1015, the transmitted pulse also travels along the paths 1056A-1056B, 1059A-1059B, 1062A-1062B, and 1063A-1063B. The paths 1056A-1056B, 1059A-1059B, 1062A-1062B, and 1063A-1063B constitute the paths that the transmitted pulse travels from the transmitter antenna 1009 to the objects 1050, 1053, 1056, and 1059, respectively, in a manner analogous to that described in connection with FIG. 11.

FIG. 14A shows the transmitted pulse 1065 as a function of time. The transmitted pulse 1065 preferably comprises an ultra-wideband pulse, or a Gaussian monocycle. FIG. 14B depicts five received pulses 1068, 1071, 1074, 1077, and 1080, which correspond to signal paths 1015, 1056A-1056B, 1059A-1059B, 1062A-1062B, and 1063A-1063B, respectively. A direct-path pulse 1068 corresponds to the signal that propagates along the direct path 1015. The direct-path signal 1068 arrives first at the receiver antenna 1012 and, therefore, constitutes the first arriving pulse. The pulse 1068 reaches the receiver antenna 1012 after a delay shown as τ₁ in FIG. 14B. The delay τ₁ represents the propagation delay from the transmitter circuitry 1003 to the receiver circuitry 1006 along the direct-path 1015, as described above.

The transmitted pulse also propagates to the objects 1050, 1053, 1056, and 1059, along paths 1056A, 1059A, 1062A, and 1063A, respectively. The transmitted pulse interacts with the objects 1050, 1053, 1056, and 1059 (e.g., reflects from the objects) and thereafter propagates to the receiver antenna 1012 15 along paths 1056B, 1059B, 1062B, and 1063B, respectively. The pulses 1071, 1074, and 1077 arrive at the receiver antenna 1012 after delays shown in FIG. 14B as τ₂, τ₃, τ₄, and τ₅, respectively. The delays τ₂, τ₃, τ₄, and τ₅ represent the propagation delays from the transmitter circuitry 1003 to the receiver circuitry 1006 along the paths 1056A-1056B, 1059A-1059B, 1062A-1062B, and 1063A-20 1063B, respectively.

FIGS. 11 and 13 show two and four objects within the multipath environments in which the communication systems 1000B and 1000C operate, respectively. A multipath environment, however, may include other numbers of objects, as persons skilled in the art would understand. In some circumstances, the multipath environment may include many objects or obstructions that give rise a correspondingly large number of multipath signals to arrive at a receiver circuitry. The multipath signals result in a transient signal at the receiver that may take a relatively long time to decay.

FIG. 15A shows the waveforms associated with a multipath environment that includes a relatively large number of objects or obstructions. FIG. 15A illustrates a transmitted pulse 1085 as a function of time. The transmitted pulse 1085 preferably comprises an ultra-wideband pulse, or a Gaussian monocycle. FIG. 15B depicts a received signal 1088. The received signal 1088 includes a first arriving-pulse that typically corresponds to the pulse that travels along the direct path from the transmitter to the receiver. The received signal 1088 also includes a plurality of other pulses that result from interactions with the objects or obstructions within the multipath environment.

Note that, because of interactions within the multipath environment, the pulses within the received signal 1088 may have varying peaks and amplitudes. In other words, constructive and destructive interference among the plurality of pulses arriving at the receiver circuitry may give rise to the plurality of pulses within the received signal 1088. Thus, the received signal 1088 has a transient component in addition to the first arriving pulse.

The transient component of the received pulse 1038 may take a relatively long time to decay. A receiver typically seeks to detect the first arriving pulse within the received pulse 1088. After it detects the First arriving pulse, the receiver may handle the transient component of the received signal 1088 in a number of ways. As one alternative, the receiver may either wait for the transient component of the received signal 1088 to decay before it tries to detect the next transmitted pulse. As noted above, however, real-life multipath environments typically include a relatively large number of obstructions. The obstructions result in a transient component in the received signal 1088 that may take a relatively long time to decay. Thus, if the receiver chooses to wait for the transient component to decay, the data throughput of the link, the overall system, or both, may suffer.

As another alternative, the RF apparatus within the communication system may employ techniques that substantially reduce or eliminate the effect of the transient component on the system's or the link's effective pulse rate or data throughput. RF apparatus according to the invention use selected codes or code sequences to accomplish an improved pulse rate or data throughput. Note that RF apparatus according to the invention do not use an a priori knowledge of the properties of the multipath environment in order to time the transmission or reception of the pulses. Rather, RF apparatus according to the invention use coding sequences that allow a link to operate with an improved pulse rate. As a result, RF apparatus according to the invention have relatively little or no sensitivity to the properties of the multipath environment. FIGS. 16-22 and their corresponding discussion below provide a mathematical foundation for the inventive concepts.

In one class of codes, a code sequence of a given length, say, N, where N is a positive integer, has two elements: an amplitude vector, a, and a time-hopping sequence, T. FIG. 16 shows an example of a code with an arbitrary length N. One may denote the amplitude vector and the time-hopping sequence as

a=(aₖ:0≦k≦N−1),

and

T=(Tₖ:0≦k≦N−1),

respectively, where the components aₖ and Tₖ constitute real numbers. (Note that one may alternatively represent the vectors as a=(a₀, a₁, a₂, . . . a_{N-1}) and T=(T₀, T₁, T₂, . . . , T_{N-1}), respectively.) Each of the components of the a vector corresponds to a component in the T vector.

A component in the T vector denotes the point in time when the code sequence has an amplitude given by the corresponding component in the a vector. Thus, the code sequence has an amplitude of a₀ at time T₀, and so on, to a_{N-1}. and T_{N-1}. Put another way, the mathematical representation of the code sequence comprises a series of delta functions translated to appropriate times that the time-hopping sequence defines. As used here, the delta function denotes the well-known Dirac delta, or unit-impulse, function, δ((t). The Dirac delta function has the properties:

$${\int }_{- ∞}^{+ ∞} δ ( t ) \cdot ⅆ t = 1 ,$$

and

δ(t)=0 for t≠0.

Thus, one may represent the code function, c(a, T), i.e., the function that provides the code sequence, as:

$$c ( a , T ) ( t ) = {\sum }_{k = 0}^{N - 1} {a}_{k} δ ( t - {T}_{k} ) .$$

To code a transmitted pulse, one convolves a pulse signal, p(t), with the code sequence, c(a, T), to obtain an impulse train, I(t):

$$I ( t ) = p ( t ) * c ( a , T ) ( t ) = {\sum }_{k = 0}^{N - 1} {a}_{k} p ( t - {T}_{k} ) ,$$

where “*” denotes the convolution operation. The convolution operation of two signals x(t) and y(t) performs the following mathematical operation:

$$x ( t ) * y ( t ) = {\int }_{- ∞}^{+ ∞} x ( λ ) \cdot y ( t - λ ) \cdot ⅆ λ , - ∞ < t < + ∞ ,$$

where λ denotes the integration variable.

FIG. 17 show the waveforms for the convolution of a pulse with a code sequence. FIG. 17A illustrates a pulse signal, p(t), which preferably comprises an ultra-wideband pulse or Gaussian monocycle. FIG. 17B shows a code sequence, c(a, T). FIG. 17C shows an impulse train, I(t), which comprises the convolution of the pulse signal, p(t), and the code sequence, c(a, T). Note that the convolution operation translates the pulse signal, p(t), to the positions and amplitudes that the code sequence, c(a, T), specifies. In other words, the convolution process delays and scales the pulse signal to the positions and amplitudes given by the code sequence. As noted above, the impulse train, I(t), represents the signal that the transmitter sends to the receiver. Note that the impulse train shown in FIG. 17C does not include any modulation by an intelligence signal, for example, any analog or digital voice signal, video signal, or data signal.

One may potentially select a code sequence from a large number of sequences available. Choosing a good or optimal code or class of codes, however, depends on how well the code or class of codes performs when used in correlation operations in a receiver. A good or optimal code or class of codes results in high receiver correlation. In other words, such a code or class of codes would help the receiver to detect the transmitted signal, rather than a random, noise, or spurious signal.

To facilitate the presentation, let us define burst-mode operation. In burst-mode operation, the transmitter repetitively transmits a set of pulses—a burst—with relatively close timing between the pulses, then waits for a period of time, before sending another set of pulses. The period of time between any two bursts is sufficiently long that the energy within the receiver from a transmitted burst dissipates before the arrival of the following burst.

In conventional pulse communication systems, operating the system in burst in a multipath environment mode may cause problems. As described above, during burst mode, the transmitter sends out a burst, or a group of pulses, with relatively close inter-pulse time spacing. Recall from FIG. 15 and its accompanying description that a single pulse transmitted in a multipath environment results in a transient signal at the receiver that may take a relatively long time to decay. In a conventional communication system, burst mode of operation would cause the transmitter to transmit a number of such pulses with relatively short inter-pulse time spacing. The receiver would receive a transmitter pulse before the energy from the previous transmitted pulse has dissipated. Without an a priori knowledge of the multipath environment and without a technique to exploit that knowledge, the receiver would be unable to detect the transmitted signals. Communication systems that incorporate RF apparatus according to the invention, however, may operate in burst mode by virtue of using codes to improve the pulse-rate of the RF apparatus.

FIG. 18 shows an example of a burst signal 1200. The burst signal includes a first group of pulses 1203, and a second group of pulses 1206, and so on. A period of time, τ_{B}, separates the two groups of pulses. Mathematically, one may represent the burst signal 1200 as

$${\sum }_{m} {σ}^{{s}_{m}} c ( {a}_{m} , {T}_{m} ) , 0 \leq m < ∞ ,$$

where

σ^{T}{f(t)}=f(t−T).

In other words, the C operator represents a delay operation that translates the function f forward in time by a duration T. As noted above, this discussion assumes no modulation of the transmitted signals. Note, however, that one may achieve modulation by, for example, using each burst as a symbol, and by sending a different sequence of pulses in each burst to denote an intelligence signal. As an example, one sequence of pulses within a burst may constitute a binary zero, whereas a different sequence of pulses may denote a binary one.

Because of the relatively long spacing in time between bursts of signal groups, a given burst signal will not materially affect the correlation in the receiver of the preceding burst signal. FIG. 19 helps to describe the correlation process in the receiver.

FIG. 19A shows a general pulse signal, p(t), that a transmitter transmits to a receiver. FIG. 19B shows a template signal, m(t), that the receiver uses during the correlation process. Note that, although FIG. 19B illustrates a simple rectangular template signal, the template signal may generally comprise other signals, as desired. FIG. 19C depicts p(t)*c(a, T), which results from convolving the pulse signal, p(t), with the code sequence, c(a, T). Thus, the waveform in FIG. 19C corresponds to the signal that the transmitter transmits to the receiver.

FIG. 19D shows a signal, m(t)*c(a, T), which results from convolving the receiver template signal, m(t), with the code sequence, c(a, T). In other words, to produce the waveform shown in FIG. 19D, the receiver convolves the template signal with a replica of the code sequence that the transmitter used to produce the waveform of FIG. 19C. The receiver may store the replica of the code sequence locally for use in the convolution process.

Note that the waveforms of FIGS. 19C and 19D differ by a phase shift denoted as τ. In other words, the waveform in FIG. 19I) lags the waveform of FIG. 19C by the time period τ. The phase-shift τ denotes an out-of-phase receiver, i.e., a receiver that has not locked onto the transmitter's signal. The receiver seeks to reduce the effects of the phase-shift τ through the synchronization and acquisition process (i.e., reduce τ to zero or relatively close to zero).

The phase-shift τ affects the results of receiver correlation operations, which provide a convenient way to gauge whether the receiver has achieved synchronization and acquisition. The correlation operation refers to the linear-correlation operator, R, defined as

$$R ( f , g ) ( τ ) ≡ {\int }_{- ∞}^{+ ∞} f ( t ) \cdot g ( t + τ ) \cdot ⅆ t ,$$

where R(f, g)(τ) represents the correlation of functions f and g. Thus, referring to FIG. 19, one may represent the receiver correlation function as

R_{RX}(τ)=R(p*c(a,T),m*c(a,T))(τ)

To evaluate the receiver correlation function, assume regular spacing between the pulses in the burst signal (i.e., the burst signal has uniform inter-pulse spacing). Denoting the constant inter-pulse time interval as Δt, one may represent the code sequence as

$$c ( a , T ) = {\sum }_{k = 0}^{N - 1} {a}_{k} δ ( t - {t}_{k} ) ,$$

where tₖ=k·Δt.

Substituting the above representation of the code into the receiver correlation, one obtains

R_{RX}(τ)=R(p*c(a,T), m*c(a,T))(τ)

or, using well-known properties of correlation functions,

R_{RX}(τ)=R(p, m)*R(c(a,T), c(a,T))(τ).

Note, however, that

$$R ( c ( a , T ) , c ( a , T ) ) ( τ ) = {\sum }_{l = - ( N - 1 )}^{N - 1} r ( a , a ) ( l ) \cdot δ ( τ - l \cdot Δ t ) , \\ where$$

$$\{ \begin{matrix}r ( a , b ) ( l ) ≡ {\sum }_{k = 0}^{N - l - 1} {a}_{k} {b}_{k + l} , ( l \geq 0 ) \\ r ( a , b ) ( - l ) ≡ {\sum }_{k = 0}^{N - l - 1} {a}_{k + l} {b}_{k} , ( l > 0 ) ,\end{matrix}$$

where

and where r(a, a) denotes the discrete auto-correlation of the code amplitude sequence, a. Hence, one may represent the receiver correlation function as

R_{RX}(τ)=R(p*c(a,T), m*c(a,T))(τ),

or

$${R}_{RX} ( τ ) = {\sum }_{l = - ( N - 1 )}^{N - 1} r ( a , a ) ( l ) \cdot R ( p , m ) ( τ - l \cdot Δ t ) .$$

Note that the receiver correlation function depends on the pulse signal, p(t), and the receiver template signal, m(t), and r(a, a), the autocorrelation of the code amplitude sequence, a.

Recall that RF apparatus according to the invention use the burst mode. Comparing performance in the burst and non-burst modes of operation provides insights into how to optimize burst-mode operation. To compare performance in the burst and non-burst modes of operation, assume that, rather than receiving a burst of pulses, a receiver receives a single pulse that has the same power as the pulses within a received burst signal. The autocorrelation r(a, a) provides a convenient means of assessing the power within a burst of pulses. When the code amplitude sequence perfectly overlaps itself, one may represent the autocorrelation r(a, a) as

$$r ( a , a ) ( 0 ) = {\sum }_{k = 0}^{N - 1} {a}_{k}^{2} .$$

To facilitate comparison of burst and non-burst modes of operation in a communication system, let us normalize the power contained within a pulse burst by assuming that

r(a, a)(0)=1.

FIG. 20 shows an example of the autocorrelation of a code sequence with normalized power.

Let us define the following mathematical quantities to facilitate the comparison. Denote the non-aligned or misaligned maxima, or maximum side-lobe, of r(a, a) and R(p, m)(τ) as

$$\overline{r ( a , a )} = max \vert r ( a , a ) ( l ) \vert$$

$$\vert l \vert > 1$$

$$and$$

$$\overline{R ( p ( t ) , m ( t ) , Δ t )} ≡ max \vert R ( p , m ) ( τ ) \vert , \\ \vert τ \vert > Δ t$$

respectively. Note that \overline{r(a, a)} signifies the ratio of the side-lobes to the main-lobe in the autocorrelation function of the code amplitude sequence.

Also define the receiver correlation of a group of pulses in a burst signal as R(p*c(a, T), m*c(a, T))(τ). Furthermore, define as R(p, m)(τ) the receiver correlation of a single pulse that has the same power as the group of pulses in a burst signal. Denote as A the absolute value of the difference in performance between using the burst and the non-burst modes of operation. In other words,

Δ≡|R(p*c(a,T),m*c(a,T))(τ)−R(p,m)(τ)|.

Using the autocorrelation of the code amplitude sequence and the correlation of the pulse signal and the template signal, one may obtain a bounding quantity for the difference in performance, Δ. In other words,

$$Δ \leq {{\sum }_{l = - ( N - 1 )}^{N - 1}}_{l \neq 0} \vert r ( a , a ) ( l ) \cdot R ( p , m ) ( τ - l \cdot Δ t ) \vert ,$$

or, alternatively,

Δ≦2·(N−1)·\overline{r(a,a)}·\overline{R(p,m,Δt)}.

The above mathematical inequality provides several clues about how one may build a communication system in which the receiver has substantially the same performance in the burst mode and the non-burst mode. First, the inequality reveals that the receiver will have substantially the same performance in the burst and non-burst modes of operation if \overline{R}(p, m, Δt)≈0. In other words, if the pulse signal and the template signal correlate well for an inter-pulse spacing of Δt, the receiver will have the substantially the same performance for burst-mode operation as it would for non-burst-mode operation. FIGS. 21 and 22 provide examples of waveforms to help illustrate that principle.

FIG. 21A shows a pulse signal, p(t), received at a receiver. FIG. 21B illustrates a receiver template signal, m(t). The template signal constitutes a simple rectangular template signal that bears little resemblance to the pulse signal of FIG. 21A. FIG. 21C shows the correlation signal, R(p, m), of the pulse signal and the template signal. One may readily observe that the pulse signal and the template signal do not correlate particularly well. Thus, one would not expect high burst-mode performance for a receiver that uses the template signal of FIG. 21B.

FIG. 22A shows the same received pulse signal, p(t), as does FIG. 21A. FIG. 22B, however, shows a template signal, m(t), that has substantially the same shape as the pulse signal of FIG. 22A. FIG. 22C depicts the correlation signal, R(p, m), of the pulse signal and the template signal of FIGS. 22A and 22B, respectively. Note that the pulse signal and the template signal correlate quite well. One would therefore expect that a receiver that uses the template signal of FIG. 22B would exhibit substantially superior performance over a receiver that uses the template signal of FIG. 21B.

The inequality Δ≦2·(N−1)·\overline{r(a,a)}·\overline{R(p, m, Δt)} also shows that the difference in performance between the burst mode and the non-burst mode vanishes if \overline{r(a, a)} equals zero or is close to zero. In other words, the receiver will detect substantially no difference between a group of pulses transmitted in the burst mode and a single pulse transmitted in the non-burst mode and with the same power as the burst signal if the side-lobes in the autocorrelation of the code amplitude-sequence are small relative to its main-lobe. Note that, ordinarily, a designer has little or no control over the term \overline{R(p,m,Δt)}. The designer, however, typically has control over the term \overline{r(a,a)}, and may improve the output pulse-rate or the system performance by reducing the term \overline{r(a,a)}. The designer may do so by selecting an appropriate code or class of codes.

For an optimal code, \overline{r(a,a)} would equal zero (i.e., the autocorrelation of the code amplitude-sequence would consist of only a main-lobe). In other words, for a perfect code the receiver would gather the same energy in the burst-mode of operation as it would in the non-burst-mode of operation. Multipath effects, however, may still degrade performance because of inter-symbol interference. One may mitigate those effects by using code sequences that are orthogonal over the length of the decay time for the multipath signals. For example, in a typical indoor RF environment, the length of the decay time may be on the order of 50 ns. Thus, a suitable code would have a duration of about 50 ns.

To achieve as high performance as possible in the burst mode (relative to the non-burst mode), one would use a code or a class of codes that has as small a ratio of side-lobes-to-main-lobe in the autocorrelation of its amplitude sequence as possible. One class of codes that has that characteristic is the family of Barker sequences. A Barker sequence of length N, where N constitutes a positive integer, has the following well-known mathematical characteristics:

$$χ ( k , 0 ) = \{ \begin{matrix}N , & k = 0 \\ \pm 1 , 0 , & k \neq 0.\end{matrix}$$

See CHARLES E. COOK & MARVIN BERNFELD, RADAR SIGNALS: AN INTRODUCTION TO THEORY AND APPLICATION 245 (1967). According to Cook and Bernfeld, no more than nine Barker sequences exist. Table 1 below lists those sequences, denoted as Cₙ:

TABLE 1
BARKER SEQUENCES

| N | {Cₙ} | χ(k, 0), k = 0, 1, . . . , (N − 1) |
|---|---|---|
| 2 | + + | 2 + |
| 2 | − + | 2 − |
| 3 | + + − | 3 0 − |
| 4 | + + − + | 4 − 0 + |
| 4 | + + + − | 4 + 0 − |
| 5 | + + + − + | 5 0 + 0 + |
| 7 | + + + − − + − | 7 0 − 0 − 0 − |
| 11 | + + + − − − + − − + − | 11 0 − 0 − 0 − 0 − 0 − |
| 13 | + + + + + − − + + − + − + | 13 0 + 0 + 0 + 0 + 0 + 0 + |

See id. Moreover, no odd Barker sequence of length greater than 13 exists. See id.

FIG. 23 shows a Barker sequence, C_{B}(a, T), of length 13. The components of the amplitude sequence of the Barker code have amplitudes of +1 and −1. The “+” indicates zero phase-shift and the “−” denotes π radians phase-shift. The Barker sequence has a time-hopping period T.

The side-lobes of the autocorrelation function of Barker sequences have the following characteristics: If N is odd and (N−1)/2 is even, then the side-lobes are always positive (e.g., N=5 or 13). If N is odd but (N−1)/2 is odd, then the side-lobes are always negative (e.g., N=3, 7, or 11). See COOK & BERNFELD, supra, at 245-46. FIG. 24 shows the autocorrelation function for the Barker sequence of FIG. 23 (i.e., length 13). See MERRILL I. SKOINIK, INTRODUCTION TO RADAR SYSTEMS 428 (2d ed. 1980). The autocorrelation function has 6 side-lobes on each side of the main-lobe. See id. Each side-lobe has a peak level of −22.3 dB below the peak level of the main-lobe. See id. The peak level of the main-lobe equals N (13 for the function shown in FIG. 24). See RADAR HANDBOOK 10.17 (Merrill I. Skolnik ed., 2d ed. 1990). Table 2 below lists the side-lobe levels for the Barker sequences of Table 1:

TABLE 2
SIDE-LOBE LEVELS OF BARKER SEQUENCES

| N | Code Elements | Side-Lobe Level (dB) |
|---|---|---|
| 2 | + + | −6.0 |
| 2 | − + | −6.0 |
| 3 | + + − | −9.5 |
| 4 | + + − + | −12.0 |
| 4 | + + + − | −12.0 |
| 5 | + + + − + | −14.0 |
| 7 | + + + − − + − | −16.9 |
| 11 | + + + − − − + − − + − | −20.8 |
| 13 | + + + + + − − + + − + − + | −22.3 |

See SKOLNIK, supra, at 429. As Table 2 illustrates, Barker sequences exhibit a relatively low ratio of side-lobe to main-lobe in their autocorrelation functions. For more discussion of Barker sequences, see the references above and the references they cite, all incorporated by reference here in their entireties.

The inventors have found that Barker sequences allow improvement of the pulse-rate of RF apparatus according to the invention. To illustrate, consider FIGS. 25A and 25B, which show two Barker sequences, C_{B}_{₁}(a, T) and C_{B}_{₂}(a, 7), respectively, of length 13 (N=13). The Barker sequence C_{B}_{₁}(a, T) has a time-hopping period T₁, whereas the Barker sequence C_{B}_{₂}(a, T) has a time-hopping period T₂, where T₁<T₂.

Consider a communication system that includes a transmitter circuitry and a receiver circuitry. The transmitter circuitry and the receiver circuitry may reside within stand-alone units, within a transceiver circuitry, within a radar circuitry, and the like, as desired. Assume that the transmitter circuitry uses the Barker sequence C_{B}_{₁}(a, T) to code the signals that it transmits to the receiver circuitry. Thus, each of the elements of the Barker sequence C_{B}_{₁}(a, T) constitutes a transmitted pulse, with the appropriate characteristics (e.g., the amplitude and phase of each pulse) governed by the Barker sequence C_{B}_{₁}(a, 7). The transmitted pulses preferably comprise ultra-wideband pulses or Gaussian monocycles. For positive elements of the Barker sequence C_{B}_{₁}(a, T), the transmitter circuitry transmits a pulse with zero phase-shift, for example, the pulse shown in FIG. 25C. For negative elements of the Barker sequence C_{B}_{₁}(a, 7), the transmitter circuitry transmits a pulse with π radians phase-shift, such as the pulse in FIG. 25D. The transmitter circuitry in effect multiplies pulses by the polarity of the elements of the Barker sequence to produce pulses that it transmits to the receiver.

The receiver circuitry preferably comprises a receiver for detecting ultra-wideband signals or Gaussian monocycles, for example, the receiver shown in FIG. 7. The receiver circuitry preferably uses coherent detection, i.e., a mixer circuitry and two integrator circuitries. The output of the second integrator circuitry (typically an integrator circuitry with a relatively long time-constant) corresponds to the detected received signal. The receiver circuitry uses the Barker sequence C_{B}_{₁}(a, T) to detect the transmitted signals. For example, the receiver circuitry may mix (i.e., multiply) each received pulse signal with a corresponding element of the Barker sequence C_{B}_{₁}(a, T).

Assume that the transmitter circuitry and the receiver circuitry operate in a multipath environment, i.e., an environment with one or more obstructions or reflectors to the transmitted RF signals. As described above, for each pulse that the transmitter circuitry transmits, the receiver circuitry receives a complex signal that comprises the combination of a direct-path signal and one or more multipath signals (i.e., signals that result from the interaction of then transmitted pulse with the multipath environment). Assume also that the transmitter circuitry transmits a pulse before the multipath signals at the receiver circuitry have decayed. In other words, the transmitter circuitry transmits a multi-pulse burst signal.

The receiver circuitry receives a composite signal. The composite signal comprises all of the transmitted pulses together with the multipath signals that result from the interaction of the transmitted pulses with the multipath environment. The receiver circuitry processes the composite received signal to produce a detected signal. As noted above, the output of the second integrator circuitry within the receiver corresponds to the detected signal. Assume that the that the transmitter circuitry transmits a selected sequence of pulses using the Barker sequence C_{B}_{₁}(a, T). Assume also that the receiver circuitry uses the Barker sequence C_{B}_{₁}(a, T) to detect those pulses, and that the detected signal has a final level, say, A_{d}_{₁}.

Now suppose that, rather than using the Barker sequence C_{B}_{₁}(a, T), the transmitter circuitry and the receiver circuitry use the Barker sequence C_{B}_{₂}(a, T) to code and decode signals, respectively. Denote as A_{d}_{₂} the level of the detected signal in the receiver circuitry that corresponds to using Barker sequence C_{B}_{₂}(a, T). Because the Barker sequences C_{B}_{₁}(a, T) and C_{B}_{₂}(a, T) have different time-hopping periods (T₁ and T₂, respectively), one would expect that A_{d}_{₁} and A_{d}_{₂} to have different values. In other words, one would anticipate that the different time-hopping periods for C_{B}_{₁}(a, T) and C_{B}_{₂}(a, T) would result in pulse sequences with differing interactions with the multipath environment, thus resulting in different composite signals at the receiver circuitry. The differing composite signals would in turn result in different values for A_{d}_{₁} and A_{d}_{₂}. The inventors, however, have made the discovery that A_{d}_{₁} and A_{d}_{₂} have substantially equal values. That result follows from using Barker sequences to code and decode signals within the communication system.

The substantially equal levels of the detected signals result, A_{d}_{₁} and A_{d}_{₂} have the implication that using Barker sequences improves the pulse-rate and, hence, the data throughput, of the communication system in a multipath environment. In other words, changing the time-hopping period of the Barker sequence is equivalent to changing the multipath environment, yet still ending up with substantially the same detected signal in the receiver circuitry. Thus, changes in the multipath environment (e.g., changes in the number of obstructions, the positions of the obstructions, or both), do not affect the ability of the receiver circuitry to receive and detect the signals that the transmitter circuitry transmits. The lack of sensitivity to multipath effects results from the use of Barker sequences within the communication system.

In addition to systems operating in the burst mode described above, coding schemes exist also for non-burst mode systems. The key performance parameter in those non-burst mode systems is still the \overline{r(a,a)} quantity described above, albeit with one modification. Specifically, in non-burst mode systems, one would use cyclic-correlation functions, rather than the non-cyclic correlation functions described above in connection with burst-mode systems.

The cyclic-correlation functions account for inter-symbol interference from preceding pulses. Similar to the burst-mode of operation, any code sequence or class of code sequences that has a \overline{r_{c}(a, a)} of relatively small magnitude (e.g., approximately zero) would allow an increase in the transmission pulse rate and, hence, tend to improve the overall performance of the communication system. Note that \overline{r_{c}(a, a)} represents \overline{r(a, a)} for cyclic-correlation calculations.

One may use RF apparatus and circuitry according to the invention in a variety of configurations and systems. FIG. 26 shows a block diagram of an exemplary embodiment 2000 of a transmitter circuitry 2003 with a transmitter code-circuitry 2006 according to the invention. The transmitter code-circuitry 2006 may reside within the transmitter circuitry 2003. Alternatively, the transmitter code-circuitry 2006 may be physically separate from the transmitter circuitry 2003, yet couple to the transmitter circuitry 2003 (e.g., through wire lines) and provide the code or sequence to the transmitter circuitry 2003. Operating together with the transmitter code-circuitry 2006, the transmitter circuitry 2003 codes the transmitted pulses in order to improve the pulse-transmission rate. The transmitter circuitry 2003 transmits the coded pulses through an antenna 2009.

FIG. 27A shows a more detailed block diagram of an exemplary embodiment 2020 of the transmitter circuitry 2003 according to the invention. The embodiment 2020 includes the transmitter code-circuitry 2006, the antenna 2009, a time-base circuitry 2023, a code source 2026, an information source 2029, a timer circuitry 2032, a pulser circuitry 2035, and a controller circuitry 2038.

The time-base circuitry 2023 provides one or more precision timing signals to the timer circuitry 2032. The code source 2026 communicates with the timer circuitry 2032 to facilitate coding the transmitted pulses for channelization, etc., as described above in more detail (note that the code circuitry 2026 performs a different function than does the transmitter code-circuitry 2006). The information source 2029 provides the intelligence signals that modulate the RF signals that the transmitter circuitry transmits.

The timer circuitry 2032 provides a signal or set of signals to the pulser circuitry 2035 that determine the timing of the transmitted pulses. In response, the pulser circuitry 2035 provides a pulse or plurality of pulses to the antenna 2009 for transmission into a propagation medium. The controller circuitry 2038 controls the operation of the timer circuitry 2032 and the pulser circuitry 2035. The transmitter-code circuitry resides within the controller circuitry 2038.

FIGS. 27B-27D depict, respectively, more detailed block diagrams of other exemplary embodiment 2050, 2060, and 2070 of the transmitter circuitry 2003 according to the invention. Generally, the embodiments 2050, 2060, and 2070 function similarly to the embodiment 2020 in FIG. 27A. Rather than residing within the controller circuitry 2003, however, the transmitter code-circuitry in FIGS. 27B-27D resides in other areas of the transmitter circuitry 2003. One may modify the transmitter circuitry 2003 to facilitate placing the transmitter code-circuitry 2006 in other parts of the transmitter circuitry 2003, as persons skilled in the art who have the benefit of this description would understand. Regardless of its location within the transmitter circuitry 2003, the transmitter code-circuitry 2006 operates overall to improve the pulse rate of the transmitter circuitry 2003.

In the embodiment 2050, the transmitter code-circuitry 2006 resides within the pulser circuitry 2035. In contrast, in the embodiment 2060, the transmitter code-circuitry 2006 resides within the timer circuitry 2032. In the embodiment 2070, the transmitter code-circuitry 2006 operates in conjunction with a multiplier circuitry 2073. The controller circuitry 2038 controls the operation of the transmitter code-circuitry 2006. Together with the multiplier circuitry 2073, the transmitter code-circuitry 2006 codes the pulses that the pulser circuitry 2035 produces. The coding process may involve changing the amplitude, the phase, or both, of the pulses. The multiplier circuitry 2073 then provides the pulses to the antenna 2009.

FIG. 28A shows a block diagram of an exemplary embodiment 2100 of a receiver circuitry 2103 with a receiver code-circuitry 2106 according to the invention. The receiver code-circuitry 2106 may reside within the receiver circuitry 2103. Alternatively, the receiver code-circuitry 2106 may be physically separate from the receiver 2106 circuitry 2003, yet couple to the receiver circuitry 2106 (e.g., through wire lines) and provide the code or sequence to the receiver circuitry 2103. Operating together with the receiver code-circuitry 2106, the receiver circuitry 2103 decodes the received pulses.

One may use high-pulse-rate RF apparatus according to the invention (i.e., RF apparatus that uses codes or code sequences for coding and decoding signals in order to improve the pulse rate) in a wide variety of communication, radar, positioning, and ranging systems. FIGS. 29-31 provide some examples of such systems.

FIG. 29A shows a system 2300 that includes a radar circuitry 2303. The radar circuitry 2303 includes a transmitter circuitry 2003, a receiver circuitry 2103, a transmitter code-circuitry 2006, a receiver code-circuitry 2106, and a mode switch 2306. The mode switch 2306 allows the radar system 2303 to operate in the transmit mode or in the receive mode, as desired. The radar system 2303 transmits and receives signals via an antenna 2309. The transmitter code-circuitry 2006 may reside within or outside the transmitter circuitry 2003, as desired. Similarly, the receiver code-circuitry 2106 may reside within or outside the receiver circuitry 2103, as desired.

In operation, the radar circuitry 2303 transmits RF pulses via the antenna 2309. The RF pulses preferably comprise ultra-wideband pulses, i.e., Gaussian monocycles. After transmitting the RF pulses, the radar circuitry 2303 switches to its receiving mode. The transmitted pulses arrive at a target 2312. The target 2312 reflects the transmitted signals. The radar system 2303 receives the reflected signals via the antenna 2309. By processing the reflected signals, the radar system 2300 can determine various characteristics of the target, such as its shape, distance, etc.

FIG. 29B illustrates a radar system 2330. The radar system 2330 is similar to the radar system 2300 in FIG. 29A. Rather than separate transmitter and receiver code circuitries, the radar system 2330 uses a transmitter/receiver code-circuitry 2333. The transmitter/receiver code-circuitry 2333 combines the functions of the transmitter code-circuitry and the receiver code-circuitry. Because the transmitter circuitry 2003 and the receiver circuitry 2103 use the same code or sequence, combining the functions of the transmitter and receiver code circuitries may reduce the number of components, overall system cost or complexity, or both. Note that, rather than using a distinct block, one may place the transmitter/receiver code-circuitry 2333 in various locations within the radar system 2300. For example, the transmitter/receiver code-circuitry may reside within the transmitter circuitry 2003 or the receiver circuitry 2103, as desired.

FIG. 30 illustrates a communication system 2340 that comprises a transmitter circuitry 2003 and a receiver circuitry 2103. The transmitter circuitry 2003 includes the transmitter code-circuitry 2006 according to the invention. Similarly, the receiver circuitry 2103 comprises the receiver code-circuitry 2106 according to the invention. The transmitter circuitry 2003 transmits signals to the receiver circuitry 2103 via the antenna 2009. The receiver circuitry 2103 receives the transmitted signals via the antenna 2109. The receiver circuitry 2103 processes the received signals, as desired, for example, by demodulating, filtering, and the like. Transmitter code-circuitry 2006 and receiver code-circuitry 2106 according to the invention improve the data throughput of the communication system 2340. Note that the transmitter code-circuitry 20015 may reside outside the transmitter circuitry 2003, as shown in FIG. 26. Likewise, the receiver code-circuitry 2106 may reside outside the receiver circuitry 2103, as FIG. 28 illustrates.

FIG. 31A depicts a communication system 2350 that comprises a first transceiver circuitry 2353A and a second transceiver circuitry 2353B. The transceiver circuitry 2353A comprises a first transmitter/receiver code-circuitry 2356A according to the invention. Similarly, the transceiver circuitry 2353B includes a second transmitter/receiver code-circuitry 2356B according to the invention. The transceiver circuitry 2353A transmits signals to, and receives signals from, transceiver circuitry 2353B via a first antenna 2359A. Similarly, The transceiver circuitry 2353B transmits signals to, and receives signals from, transceiver circuitry 2353A via a second antenna 23519B. Each of the first transceiver circuitry 2353A and the second transceiver circuitry 2353B processes the received signals, as desired, for example, by demodulating, filtering, and the like. The transmitter/receiver code-circuitry 2356A and 2356B improve the pulse rates of the transceiver circuitries 2353A and 2353B, respectively.

Note that the transmitter/receiver code-circuitry 2356A and 2356B may reside outside the transceiver circuitries 2353A and 2353B, respectively, yet couple to the transceiver circuitries 2353A and 2353B (e.g., coupled through wire lines). Note also that, rather than using a first transceiver circuitry 2353A and a second transceiver circuitry 2353B in a communication system, one may employ a system that comprises a transmitter circuitry and one or more transceiver circuitries. The transmitter circuitry and the transceiver circuitry may include code circuitries according to the invention, as desired.

FIG. 31B shows an embodiment 2370 of a communication system. The embodiment 2370 constitutes a variation of the embodiment 2350 of FIG. 31A. The embodiment 2370 comprises the first transceiver circuitry 2353A and the second transceiver circuitry 2353B. The first transceiver circuitry 2353A and the second transceiver 2353B each comprise a transmitter code-circuitry and a receiver code circuitry. The transceiver circuitry 2353A comprises a first transmitter code-circuitry 2373A and a first receiver code-circuitry 2376A according to the invention. Similarly, the transceiver circuitry 2353B includes a second transmitter code-circuitry 2373B and a receiver code-circuitry 2376B according to the invention. The transmitter code circuitries 2373A-2373B and the receiver code-circuitries 2376A-2376B improve the pulse rates of the transceiver circuitries 2353A and 2353B.

Note that the transmitter code-circuitries 2373A-2373B and the receiver code-circuitries 2376A-2376B may reside outside the transceiver circuitries 2353A and 2353B, respectively, yet couple to the transceiver circuitries 2353A and 2353B (e.g., through wire lines). Note also that, rather than using a first transceiver circuitry 2353A and a second transceiver circuitry 2353B in a communication system, one may employ a system that comprises a transmitter circuitry and one or more transceiver circuitries. The transmitter circuitry and the transceiver circuitry may include code circuitries according to the invention, as desired.

Further modifications and alternative embodiments of this invention will be apparent to persons skilled in the art in view of this description of the invention. Accordingly, this description teaches those skilled in the art the manner of carrying out the invention and are to be construed as illustrative only. The forms of the invention shown and described should be taken as the presently preferred embodiments.

Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

We claim:

1. A radio-frequency (RF) apparatus, comprising:
a transmitter circuitry configured to transmit a plurality of pulses into a multipath propagation medium; and
transmitter code-circuitry coupled to the transmitter circuitry, the transmitter code-circuitry configured to code the plurality of pulses so as to improve the output pulse-rate of the transmitter circuitry.

2. A radio-frequency (RF) circuitry with improved output pulse-rate, comprising:
an antenna;
a transmitter circuitry configured to provide a plurality of output pulses;
a code circuitry configured to supply a plurality of code pulses, the plurality of code pulses selected so as to improve the output pulse-rate of the transmitter circuitry; and
a multiplier circuitry coupled to the transmitter circuitry, the code circuitry, and the antenna, the multiplier circuitry configured to multiply each of the plurality of output pulses with a corresponding pulse in the plurality of code pulses, and to provide the resulting product to the antenna.

3. A radio-frequency (RF) system, comprising:
a transmitter circuitry configured to provide a plurality of output pulses to a propagation medium, the transmitter circuitry including transmitter code-circuitry configured to code the plurality of output pulses so as to improve the output pulse-rate of the transmitter circuitry; and
a receiver circuitry configured to receive the plurality of output pulses from the propagation medium, the receiver circuitry including receiver code-circuitry configured to decode the plurality of output pulses.

4. A method of improving an output pulse-rate of a radio-frequency (RF) apparatus, comprising:
providing a transmitter circuitry configured to provide a plurality of output pulses;
providing a transmitter code circuitry; and
coding the plurality of output pulses so as to improve the output pulse-rate of the radio-frequency apparatus.

5. A method of improving the output pulse-rate of a radio-frequency (RF) apparatus, comprising:
providing an antenna;
providing a transmitter circuitry configured to supply a plurality of output pulses;
coding the plurality of output pulses by using a plurality of code components selected so as to improve the output pulse-rate of the radio-frequency apparatus;
multiplying each of the plurality of output pulses with a corresponding component in the plurality of code components to provide a plurality of product signals; and
supplying each of the plurality of product signals to the antenna.

6. A method of improving the pulse transmission rate in a radio-frequency (RF) system, comprising:
providing a transmitter circuitry configured to provide a plurality of output pulses to a propagation medium;
coding the plurality of output pulses, by using a transmitter code-circuitry that supplies a plurality of code pulses configured to improve the output pulse rate of the transmitter circuitry;
providing a receiver circuitry configured to receive the plurality of output pulses from the propagation medium; and
decoding the plurality of output pulses by using a receiver code-circuitry.
